(19) United States
(12) Patent Application Publication
(10) Pub. No.: US 2015/0154371 A1
(43) Pub. Date: Jun. 4, 2015

(54) HEALTH DATA SYSTEM AND METHOD

(71) Applicant: Welkin Health, Inc., San Francisco, CA (US)

(72) Inventors: Gideon Wald, San Francisco, CA (US); Chase Hensel, San Francisco, CA (US)

(21) Appl. No.: 14/557,852

(22) Filed: Dec. 2, 2014

Related U.S. Application Data
(60) Provisional application No. 61/910,723, filed on Dec. 2, 2013.

(51) Int. Cl. G06F 19/00

(52) U.S. Cl. CPC G06F 19/3418; G06F 19/321; G06F 19/3475

(57) ABSTRACT

Techniques of processing health data are disclosed. An end-to-end system is provided, encompassing both user-interface innovations on the patient client side and novel back-end innovations to interpret the data and structure it for caregivers and for the patients themselves. In some embodiments, photography is employed as a mechanism to obtain data.

### CROSS-REFERENCE TO RELATED APPLICATIONS

This application claims priority to U.S. Provisional Application No. 61/910,723, filed on Dec. 2, 2013, entitled, “HEALTH DATA SYSTEM AND METHOD,” which is hereby incorporated by reference in its entirety as if set forth herein.

### TECHNICAL FIELD

The present application relates generally to the technical field of data processing, and, in various embodiments, to systems and methods of efficiently processing health data.

### BACKGROUND

Type II diabetes is a complex and multi-faceted condition. Diabetics must keep consistent track of many different types of information in order to effectively manage their disease. Some of the most important types of information are: biometric data, such as blood glucose levels, which are traditionally gathered with the help of a special-purpose device (e.g., glucometer); behavioral data, such as how often the patient is exercising and whether they are taking their medication regularly; and nutritional information (calories, carbohydrates, fat, sugar, etc.) about what the patient is consuming. The current standard of care for diabetes offers no unified or convenient way for patients to (1) record and keep track of this large variety of data and (2) share it with their health care providers. This lack of solutions regarding health data also extends to other health matters and medical conditions beyond just diabetes. Furthermore, current approaches fail to provide health care providers with efficient tools for managing and processing health data for their patients.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a network diagram illustrating a client-server system, in accordance with some example embodiments;

FIG. 2 illustrates a graphical user interface that can be used to capture health-related images, in accordance with some example embodiments;

FIG. 3 illustrates a graphical user interface being used to annotate a captured image of food, in accordance with some example embodiments;

FIG. 4 illustrates a graphical user interface being used to annotate a captured image of a meter reading, in accordance with some example embodiments;

FIGS. 5-6 illustrate a graphical user interface being used to determine an award for user activity, in accordance with some example embodiments;

FIGS. 7-9 illustrate a graphical user interface displaying an award being issued to a user, in accordance with some example embodiments;

FIG. 10 is a flowchart illustrating a method of image processing, in accordance with some example embodiments;

FIG. 11 is a flowchart illustrating a method of determining an engagement approach, in accordance with some example embodiments;

FIG. 12 is a flowchart illustrating a method of implementing an engagement approach, in accordance with some example embodiments;

FIG. 13 is a flowchart illustrating a user outreach method, in accordance with some example embodiments;

FIG. 14 is a flowchart illustrating another method of image processing, in accordance with some example embodiments;

FIG. 15 is a flowchart illustrating a method of maintaining a history of user activity, in accordance with some example embodiments;

FIG. 16 is a flowchart illustrating a method of providing a notification, in accordance with some example embodiments;

FIG. 17 is a flowchart illustrating a method of providing health management services, in accordance with some example embodiments;

FIG. 18 is a flowchart illustrating a method of providing real-time health-related information regarding food, in accordance with some example embodiments;

FIGS. 19A-19B illustrate a graphical user interface being used to identify different types of food on a plate, in accordance with some example embodiments;

FIGS. 20A-20E illustrate a graphical user interface being used to manage health-related data of patients, in accordance with some example embodiments;

FIG. 21 is a block diagram illustrating health data modules, in accordance with some example embodiments;

FIGS. 22-26 illustrate notifications, in accordance with some example embodiments;

FIG. 27 illustrates an inbox of notifications for a health care provider, in accordance with some example embodiments;

FIG. 28 illustrates a logic of an intervention, in accordance with some example embodiments;

FIG. 29 is a flowchart illustrating a method of annotating data, in accordance with some example embodiments;

FIG. 30 is a flowchart illustrating a method of transmitting a notification, in accordance with some example embodiments;

FIG. 31 is a flowchart illustrating a method of prioritizing notifications, in accordance with some example embodiments;

FIG. 32 is a flowchart illustrating a method of channel optimization for a message, in accordance with some example embodiments;

FIG. 33 is a flowchart illustrating a method of content optimization for a message, in accordance with some example embodiments;

FIG. 34 is a flowchart illustrating a method of intervention management, in accordance with some example embodiments;

FIG. 35 is a block diagram illustrating a mobile device, in accordance with some example embodiments; and

FIG. 36 is a block diagram of an example computer system on which methodologies described herein may be executed, in accordance with an example embodiment.

### DETAILED DESCRIPTION

Example methods and systems of processing health data are disclosed. In the following description, for purposes of explanation, numerous specific details are set forth in order to provide a thorough understanding of example embodiments. It will be evident, however, to one skilled in the art that the present embodiments may be practiced without these specific details.

In some example embodiments, a first plurality of selectable user interface (UI) elements can be caused to be displayed on a mobile device of a first user. Each one of the first plurality of selectable UI elements can indicate a distinct image category. A user selection, by the first user, of one of the first plurality of selectable UI elements can be received. Image data captured by an image capture device on the mobile device can be received. A second plurality of selectable UI elements can be determined to be displayed on the mobile device based on the user selection of the one of the first plurality of selectable UI elements. The determination of the second plurality of selectable UI elements can be responsive to a user-generated interrupt corresponding to the user selection, and each one of the second plurality of selectable UI elements can indicate distinct annotation data with which to associate the received image data. The second plurality of selectable UI elements can be caused to be displayed on the mobile device. A user selection, by the first user, of one of the second plurality of UI elements can be received. The annotation data corresponding to the selected one of the second plurality of UI elements can be associated with the received image data. The annotation data and the received image data can be further associated with the first user for processing by an online health provider service with which the first user is registered.

In some example embodiments, the first plurality of selectable UI elements comprises a first selectable UI element indicating a food image category for food data and a second selectable UI element indicating a measurement image category for medical device measurement data.

In some example embodiments, it can be determined that the first user has failed to satisfy one or more predetermined criteria for user engagement. The one or more predetermined criteria for user engagement can comprise a predetermined minimum level of submission of image data corresponding to one of the image categories of the first plurality of selectable UI elements. A notification can be transmitted to one or more other users different from the first user based on the determination that the first user has failed to satisfy the one or more predetermined criteria for user engagement. The notification can comprise an indication that the first user has failed to satisfy the predetermined minimum level of submission of image data. In some example embodiments, it can be determined that the first user has satisfied one or more predetermined criteria for user engagement. A notification can be transmitted to one or more other users different from the first user based on the determination that the first user has satisfied the one or more predetermined criteria for user engagement. The notification can comprise an indication that the first user has satisfied the predetermined minimum level of submission of image data.

In some example embodiments, a plurality of notifications for a second user different from the first user can be generated. Each one of the plurality of notifications can correspond to a different patient of the second user. A corresponding priority value can be determined for each one of the plurality of notifications based on one or more priority factors that are independent from any direction by the corresponding patient for the corresponding priority value of the corresponding notification. A presentation configuration of the plurality of notifications can be determined based on their corresponding priority values. The plurality of notifications can be caused to be displayed to the second user based on the presentation configuration.

In some example embodiments, the one or more priority factors can comprise at least one of a classification of the corresponding notification, health status information of the corresponding patient of the corresponding notification, historical information of interaction by the corresponding patient of the corresponding notification with the online health provider service, intervention information indicating one or more approaches for providing support to the corresponding patient of the corresponding notification, and information indicating a level of availability of the second user.

In some example embodiments, determining the presentation configuration comprises ranking the plurality of notifications based on their corresponding priority values, and causing the plurality of notification to be displayed to the second user based on the presentation configuration comprises causing at least a portion of the plurality of notifications to be displayed on a page based on the ranking.

In some example embodiments, determining the presentation configuration comprises determining an indication of the corresponding priority value for each one of the plurality of notifications, and causing the plurality of notification to be displayed to the second user based on the presentation configuration comprises causing at least a portion of the plurality of notifications to be displayed on a page along with their corresponding indications of their corresponding priority values.

In some example embodiments, a message for the first user is generated. At least one channel of communication from a plurality of channels of communication can be selected for the message based on at least one of profile information of the first user, a classification of the message, and content of the message. The message can be transmitted to the first user via the selected channel(s) of communication.

In some example embodiments, a channel of communication can be determined for a message for the first user. Content of the message can be determined based on the determined channel of communication. The message can be generated to include the determined content. The generated message can be transmitted to the first user via the determined channel of communication. In some example embodiments, an intervention configuration input can be received from a second user different from the first user. The intervention configuration input can be configured to configure an intervention for the first user. The intervention can comprise one or more rules defining one or more actions to be performed in response to a determination of one or more corresponding conditions associated with the first user. The one or more actions to be performed can comprise sending a notification to the first user, the second user, and/or some other user different from the first user. The intervention can be configured based on the intervention configuration input and stored in a database. The configured intervention can then be applied to data associated with the first user.

The methods, features, and embodiments disclosed herein may be implemented as a computer system having one or more modules (e.g., hardware modules or software modules). Such modules may be executed by one or more processors of the computer system. In some embodiments, a non-transitory machine-readable storage device may store a set of instructions that, when executed by at least one processor, causes the at least one processor to perform the operations and method steps discussed within the present disclosure.

The present disclosure describes a system that is simple to interact with, requires minimal cognitive effort on the patient's part, and makes health-related data immediately available in a convenient and useful format so that a caregiver or other experts can give patient-specific health advice, thereby helping patients with diabetes effectively manage a large variety of diagnostic information. An end-to-end system is disclosed, encompassing both user-interface (UI) innovations on the patient client side, as well as novel back-end innovations to interpret the data and structure it for caregivers. In some embodiments, photography is employed as a mechanism at the heart of a multi-purpose system satisfying the above needs.

Many other chronic conditions have many of the same characteristics as diabetes in the domains above. Accordingly, the techniques disclosed herein are not merely applicable to the care of patients with diabetes, but are also extensible to the care of patients with other medical conditions (e.g., cardiovascular disease).

The system and features of the present disclosure may be employed using a client-server architecture, but are not limited to such an architecture, and could also find application in a distributed, or peer-to-peer, architecture system, for example.

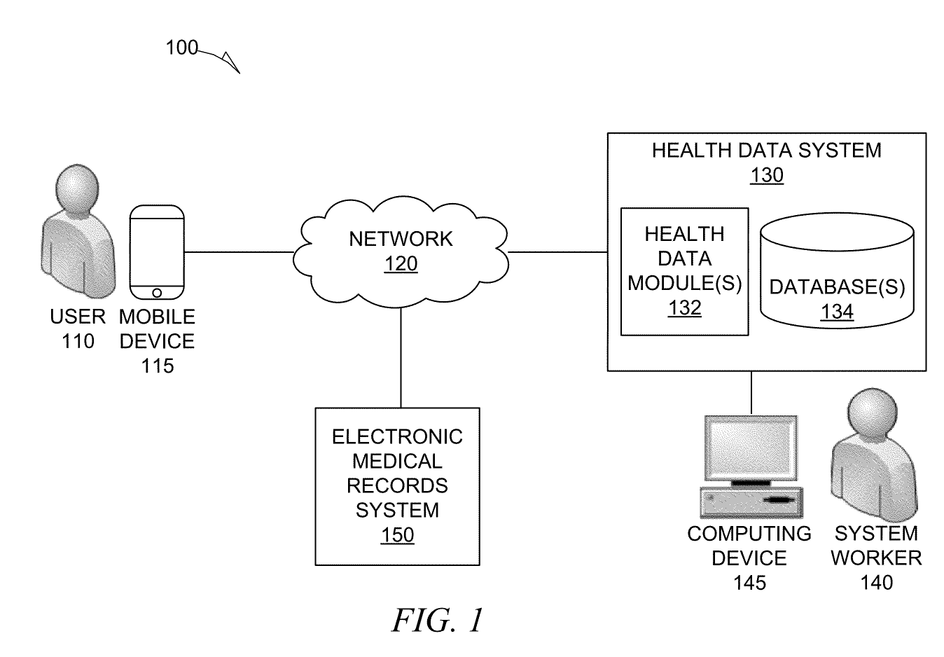

FIG. 1 is a network diagram illustrating a client-server system 100, in accordance with an example embodiment. In the client-server system 100, a user 110 (e.g., a health care patient) can provide information to a health data system 130 using a mobile device 115. The health data system 130 can reside on one or more servers separate and remote from the mobile device 115. The mobile device 115 may be a mobile phone or a tablet computer. Other mobile devices are also within the scope of the present disclosure. Furthermore, it is contemplated that other devices may be used by the user 110 to provide information to the health data system 130. In some embodiments, a mobile application residing on the mobile device 115 is configured to enable the user 110 to capture images that can be used to analyze the health-related activity of the user 110. The mobile application can also be configured to enable the user 110 to annotate the captured images and to upload the images and annotations to the health data system 130 for processing.

The term “client” is used herein to refer to a device or application being used by the user 110 (e.g., mobile device 115). The term “server” is used herein to refer to the health data system 130 or its components. Although reference is made herein to certain operations being performed by or on a client and other operations being performed by or on a server, it is contemplated that other configurations are also within the scope of the present disclosure. Accordingly, any combination of the operations described as being performed by or on a client may be performed by or on a server. Similarly, any combination of the operations described as being performed by or on a server may be performed by or on a client.

In some embodiments, the communication of information between devices and machines disclosed herein, such as the communication of information between the user 110 on the mobile device 115 and the health data system 130, may be sent via one or more networks 120. The one or more networks 120 may comprise any network that enables the corresponding type of communication between or among machines, databases, and devices. Accordingly, the one or more networks 120 may include, but are not limited to, a wired network, a wireless network (e.g., a mobile or cellular network), or any suitable combination thereof. The one or more networks 120 may include one or more portions that constitute a private network, a public network (e.g., the Internet), or any suitable combination thereof.

The health data system 130 may comprise health data module(s) 132 and one or more databases 134. Although health data module(s) 132 and database(s) 134 are shown as residing within health data system 130, which is separate and remote from the mobile device 115, it is contemplated that health data module(s) 132 and/or database(s) 134 can reside wholly or partially on the mobile device. In some example embodiments, some portion of health data module(s) 132 and/or database(s) 134 can reside on the mobile device 115 while the remaining portion of health data module(s) 132 and/or database(s) 134 can reside on one or more separate and remote servers.

Users, such as user 110, can be registered with the health data system 130, and their associated user records may be stored in the database(s) 134. These user records may comprise a variety of information about the users, such as profile information (e.g., name, contact information, etc.) and medical history/background information (e.g., age, medical conditions, etc.). The user records can also include user activity information. As will be discussed in further detail below, this user activity information can be acquired and/or derived from the information provided by the user 110 using the mobile device 115. As will also be discussed in further detail below, the health data module(s) 132 may be configured to receive and process any of this information provided by the user 110 or stored in the database(s) 134. The health data module(s) 132 may also be configured to provide information back to the user 110 based on its processing (e.g., analysis) of information associated with the user 110. The health data module(s) 132 may also be configured to provide information to other users (e.g., family/friends of user 110 or other health care patients grouped with user 110) based on its processing of information associated with the user 110.

In some embodiments, one or more system workers 140 can operate the processing of the information associated with the user 110 by the health data module(s) 132. A system worker 140 can include any person affiliated with or contributing to the performance of the services being provided by the health data system 130. Examples of system workers 140 include, but are not limited to, nutritionists, physical therapists, doctors, nurses, and data analysts. In some embodiments, the term “user” additionally or alternatively comprises a system worker 140. The system workers 140 may direct the processing of the information associated with the user 110 via a computing device 145. Examples of computing devices include, but are not limited to, desktop computers, laptop computers, tablet computers, and smartphones.

In some embodiments, the health data system 130 may be configured to communicate with an electronic medical records system 150 of a medical facility, such as a hospital or doctor's office. The health data system 130 may also be configured to communicate with a pharmacy associated with the user 110.

The features of the present disclosure enable the user 110 to upload many types of data as simply and painlessly as possible. The interface for uploading the data may comprise a simple flow with only a few steps. This flow can be straightforward, fast, and standardized for all of the different types of data that the user 110 will upload. In some embodiments, the user 110 can activate a user interface affordance for taking a photo (or otherwise capturing an image) via the mobile application on the mobile device 115.

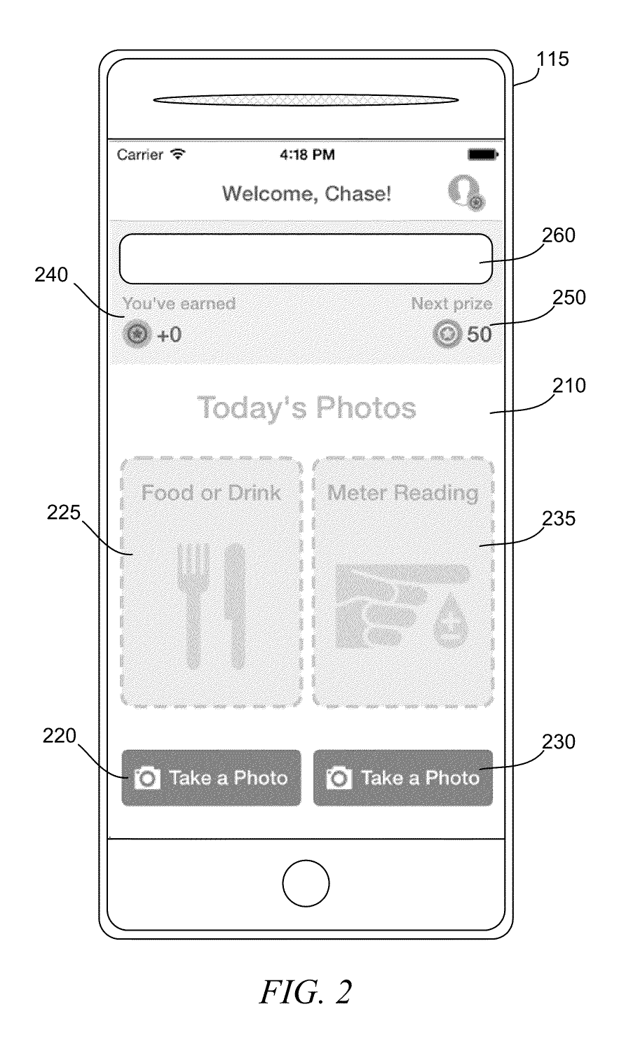

FIG. 2 illustrates a graphical user interface 210 that can be used to capture health-related images, in accordance with example embodiments. In some embodiments, there is only a single affordance to trigger the camera on mobile device 115. In other embodiments, there are multiple entry points to the camera depending on what type of information the user 110 wants to upload to the health data system 130. In the graphical user interface 210, selectable user interface elements 220 and 230 (e.g., selectable buttons) may be presented to the user 110 to enable the user 110 to activate the camera mode on the mobile device 115. Image placeholder areas 225 and 235 may be provided to identify the area in the graphical user interface 210 where images captured by the camera of the mobile device 115 will be displayed subsequent to the capturing of the images. For example, image placeholder area 225 may identify the area where a captured image resulting from the initiation of the camera mode by the selection of selectable user interface element 220 will be displayed, while image placeholder area 235 may identify the area where a captured image resulting from the initiation of the camera mode by the selection of selectable user interface element 230 will be displayed. In some embodiments, the image placeholder areas 225 and 235 may be identified as corresponding to particular types of images. For example, image placeholder area 225 may correspond to images of food or a drink, whereas image placeholder area 235 may correspond to images of a health-related meter reading (e.g., glucometer reading, blood-pressure monitor reading, pedometer reading, etc.).

In some embodiments, in response to the selection of one of the selectable user interface elements 220 or 230, a standard camera interface may be presented on the mobile device 115. The camera interface can then be used by the user 110 to take a photo of something that contains the information the user 110 desires to upload (e.g., a meal, a glucometer screen, a pedometer, etc.).

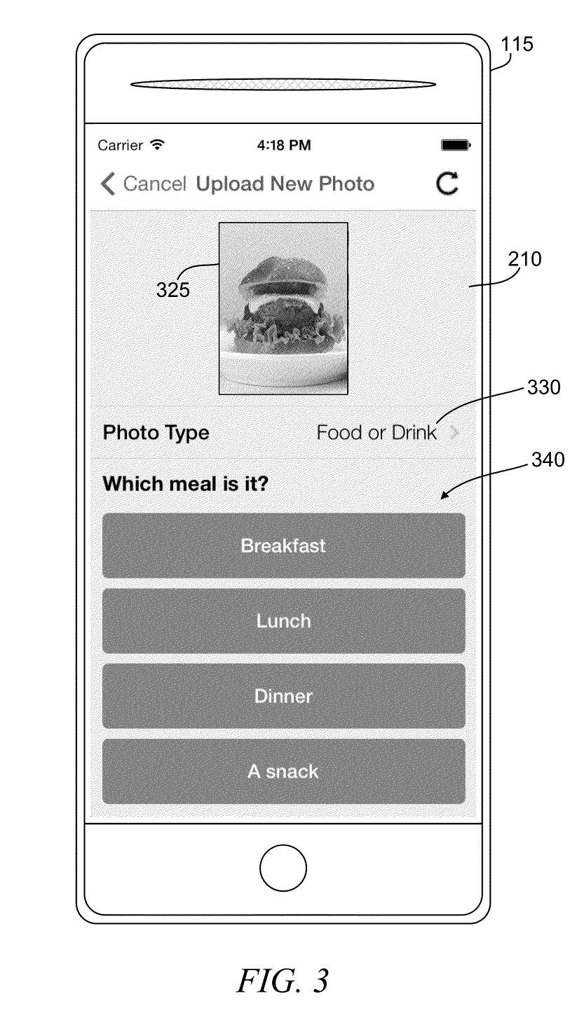

In some embodiments, a user interface is provided that enables the user to annotate the captured photo with various pieces of information about its properties, such information specifying what kind of data the photo represents. FIG. 3 illustrates graphical user interface 210 enabling the user 110 to annotate a captured image 325 of food, in accordance with example embodiments. Here, the graphical user interface 210 may display photo type information 330 that indicates what type of photo has been captured. For example, in FIG. 3, the user 110 has selected the selectable user interface element 220 (from FIG. 2), which corresponds to the food or drink photos, and has taken a picture of a hamburger. Accordingly, the photo type information 330 indicates that the photo is of “Food or Drink.” In some embodiments, an image annotation area 340 is provided. In this example, the image annotation area 340 comprises a plurality of selectable interface elements from which the user 110 can select in order to indicate what meal (Breakfast, Lunch, Dinner, A snack) to which the captured image 325 corresponds. The captured image 325 and its corresponding annotations (e.g., photo type information 330, identification of a meal type (e.g., Lunch)) may then be uploaded to the health data system 130. In some embodiments, the annotation/sorting of captured photos is performed on the backend by the health data system 130.

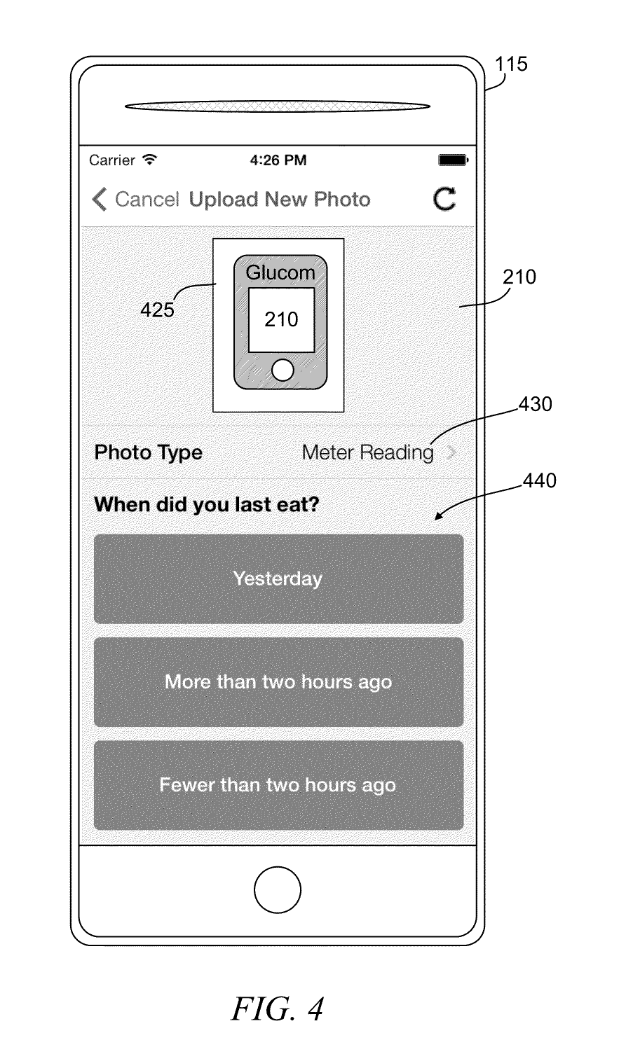

FIG. 4 illustrates a graphical user interface 210 enabling the user 110 to annotate a captured image 425 of a meter reading, in accordance with example embodiments. Here, the graphical user interface 210 may display photo type information 430 that indicates what type of photo has been captured. For example, in FIG. 4, the user 110 has selected the selectable user interface element 230 (from FIG. 2), which corresponds to the meter reading photos, and has taken a picture of a glucometer reading. Accordingly, the photo type information 430 indicates that the photo is of a “Meter Reading.” In some embodiments, an image annotation area 440 is provided. In this example, the image annotation area 440 comprises a plurality of selectable interface elements from which the user 110 can select in order to indicate when the user last ate (Yesterday, More than two hours ago, Fewer than two hours ago) to which the captured image 425 corresponds. The captured image 425 and its corresponding annotations (e.g., photo type information 430, identification of when the user last ate (e.g., More than two hours ago)) may then be uploaded to the health data system 130. In some embodiments, the annotation/sorting of captured photos is performed on the backend by the health data system 130.

In some embodiments, the mobile application on the mobile device 115 is configured to enable the user 110 to initiate a photo upload for a specific kind of information. The captured image may also be automatically annotated with the type of photo (e.g., food/drink or meter reading) based on the selection of the corresponding selectable user interface element (e.g., selectable user interface elements 220 or 230) that leads to the capturing of the corresponding image. In some embodiments, the mobile application is configured to determine the plurality of selectable interface elements for annotation based on the user's selection of the type of photo that he or she will be taking. For example, if the user selects selectable user interface element 220 to take a photo of a food or a drink, then the image annotation area 340 can include selectable interface elements that correspond to data (e.g., Breakfast, Lunch, Dinner, Snack) which the photo will be annotated with upon selection, whereas if the user selects user interface element 230 to take a photo of a health-related meter reading, then the image annotation area 440 can include selectable interface elements that correspond to data (e.g., Yesterday, More than two hours ago, Fewer than two hours ago) which the photo will be annotated with upon selection. In this respect, the user's selection of what type of photo to take can determine what type of annotation options are available and presented to the user. In the examples of FIGS. 2-4, either a photo of a meal (for nutrition information), or a photo of a glucometer (for a blood sugar reading) may be uploaded. In some embodiments, the mobile application on the mobile device 115 is configured to enable the user 110 to simply take and upload a generic photo. Additional embodiments may either offer opportunities for the user 110 to describe the photo later in the flow, or rely on the backend health data system 130 to determine the type of information being uploaded.

The examples above only discuss two kinds of information: (1) nutritional information from food/drink; and (2) blood glucose readings. However, the features of the present disclosure can be extended to encompass other types of user information. For example, user 110 can take photos of: (a) his pillbox to show how regular he has been about his medication adherence; (b) a simple pedometer to show how much he has walked; (c) a scale to record his weight; or (d) a blood-pressure cuff to record blood pressure measurements. The simplicity and concision of this flow means that the user 110 can complete the process of uploading a myriad of data types within 30 seconds with no expensive connected devices needed and without any cognitive load of needing to figure out the right upload mechanism.

In some embodiments, the health data system 130 is configured to provide incentives to the user 110 for engaging in certain behavior, which may be indicated by the user 110 performing certain actions. This behavior may include, but is not limited to, satisfying certain health-related requirements and/or by simply engaging or participating in the services offered by the health data system 130. Examples of health related requirements include, but are not limited to, nutritional requirements (e.g., standards for calories, fat, carbohydrates, sugar, etc.), medical measurement requirements (e.g., standards for blood pressure, glucose level, heart rate, etc.), and exercise requirements (e.g., how many steps taken in a day or week, which may be determined using a pedometer). Examples of the user 110 engaging or participating in the services offered by the health data system 130 include, but are not limited to, the user 110 uploading photos of meals or medical measurements (e.g., glucometer readings).

It is contemplated that the incentives may be provided in a variety of ways and in a variety of forms. In some embodiments, the health data system 130 awards points to the user 110 based on indications of behavior of the user 110 received by the health data system 130. For example, the health data system 130 may award points to the user 110 every time the user 110 uploads a photo of a meal within a certain time requirement. The health data system 130 can store and accumulate a point total for the user 110. The health data system 130 can also award the user 110 a prize in response to the user 110 accumulating a certain number of points. Incentives can include, but are not limited to, money, coupons, and information.

Referring back to FIG. 2, the graphical user interface 210 may present an indication of a point total 240 for the user 110 and an indication of a point level 250 that needs to be reached by the user 110 in order for the user 110 to be awarded a prize. A progress bar 260 (or other graphical user interface element) may be displayed to indicate how close the user 110 is to reaching the point level 250 for the prize.

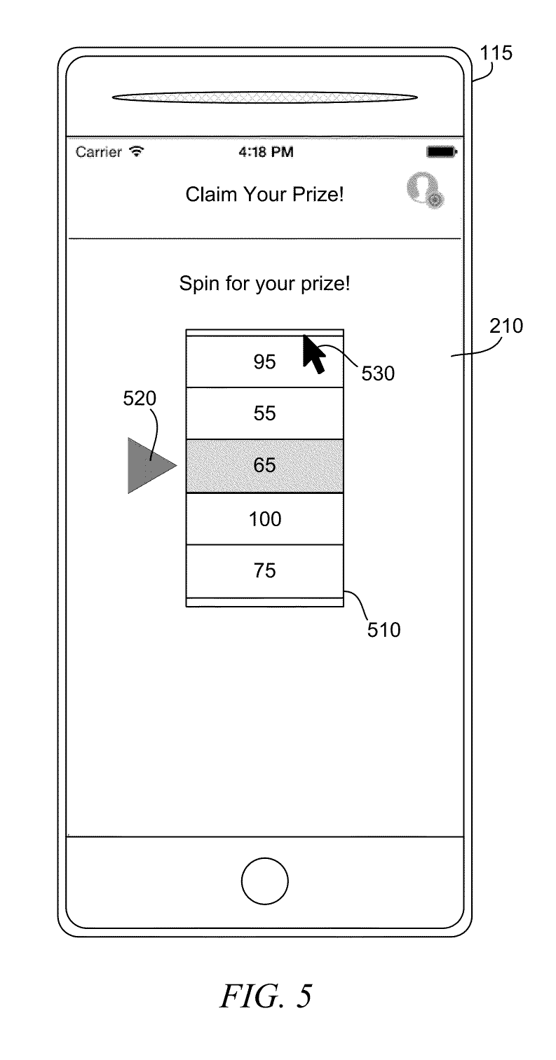

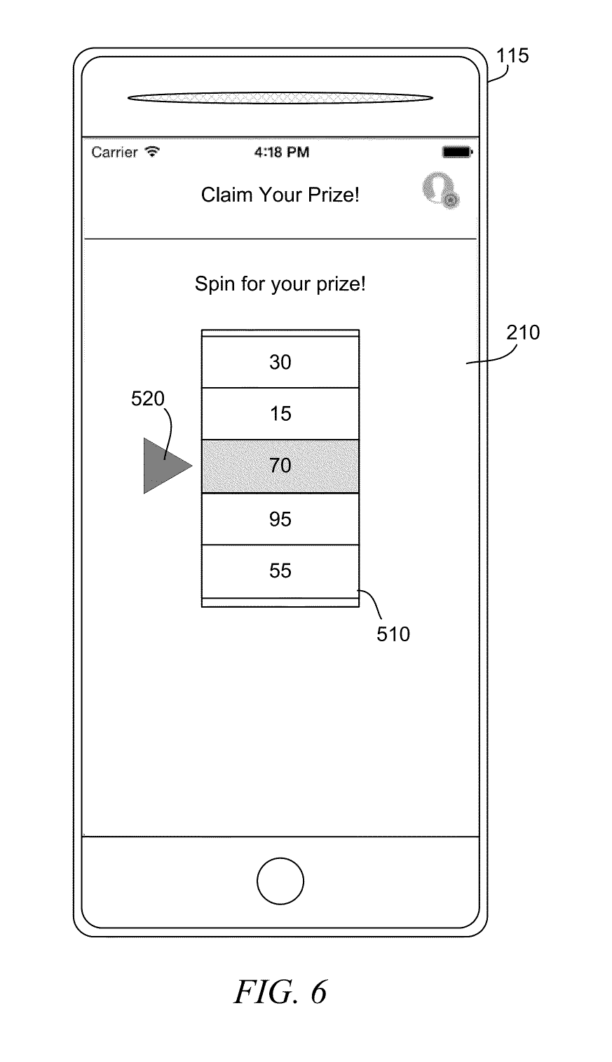

In some embodiments, the health data system 130 can award points or prizes to the user 110 based on a stochastic method. In FIG. 5, subsequent to the user 110 performing an action that satisfies an award requirement (e.g., uploading the captured image 325 of the hamburger), the number of points to be awarded to the user 110 may be determined by the user 110 spinning a wheel 510 of point values. The user 110 may spin the wheel 510, such as by using a pointer 530 or by swiping a finger across the screen of the mobile device 115. An arrow 520 (or other graphical user interface element) may be used to indicate what point value on the wheel 510 will be awarded to the user 110. For example, in FIG. 5 before the wheel 510 has been spun, the arrow 520 points to a value of “65.” In FIG. 6 after the wheel 510 has been spun, the arrow 520 points to a value of “70.” As a result, the user 110 may be awarded 70 points.

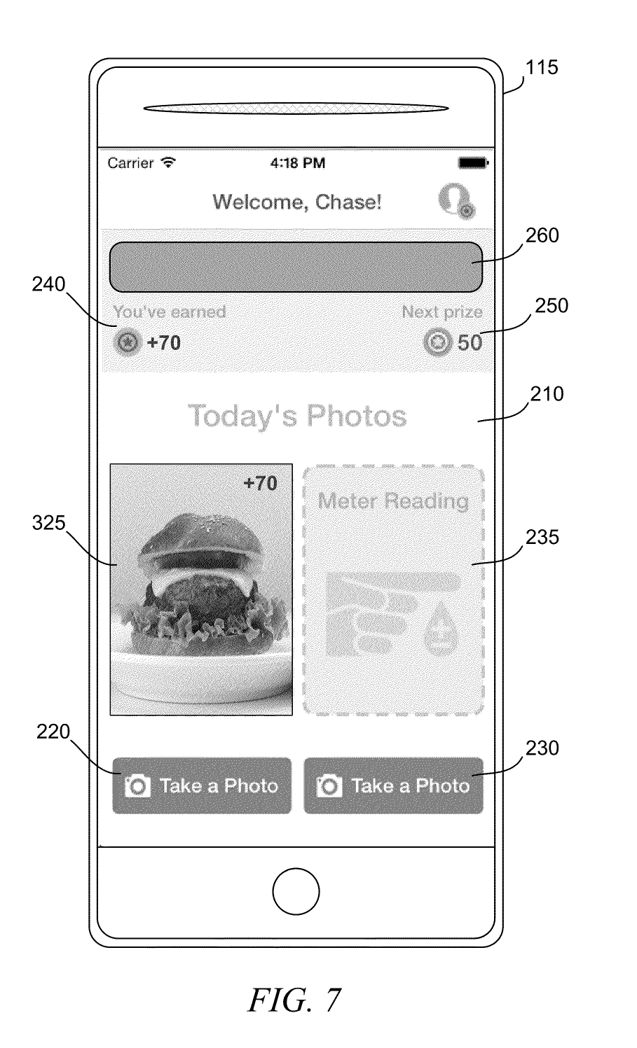

In FIG. 7, the progress bar 260 and the indication of the point total 240 for the user 110 are updated to reflect the user 110 being awarded 70 points. Additionally, the captured image 325 may be displayed in the image placeholder area 225.

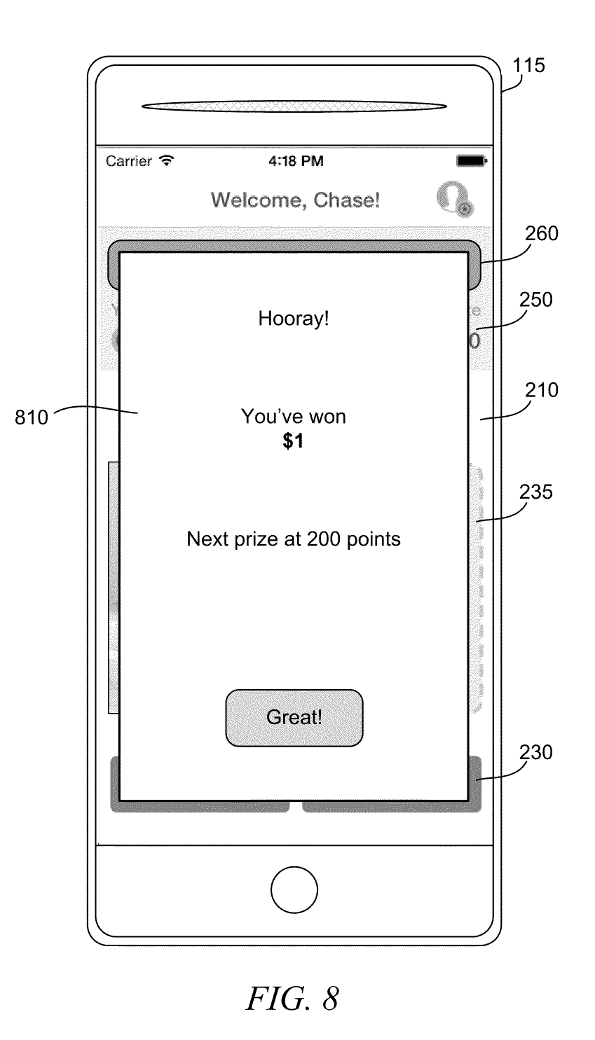

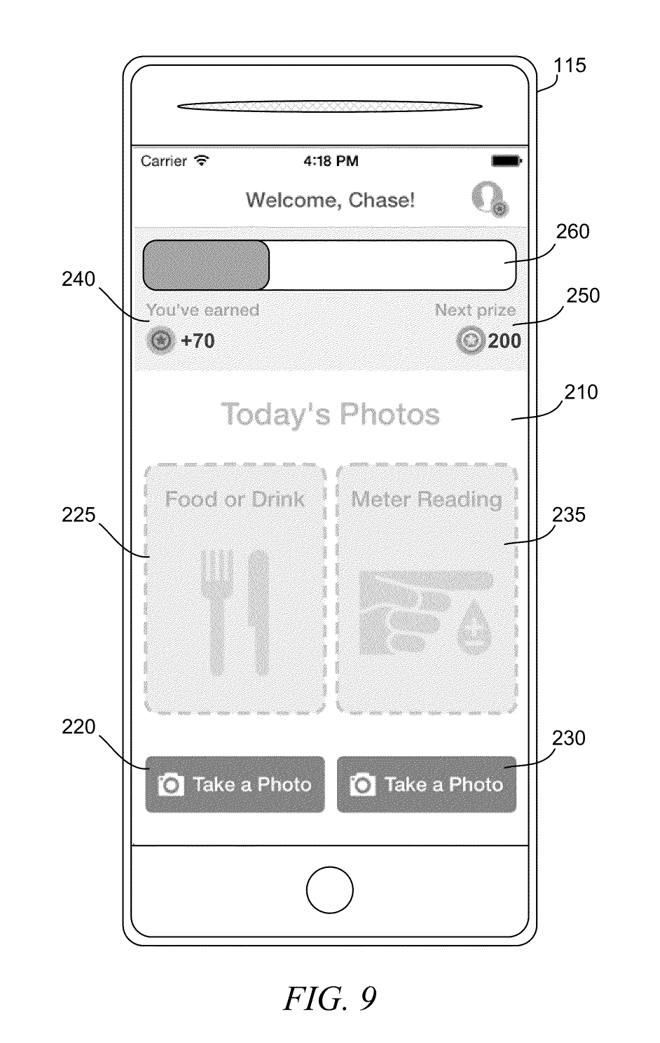

The health data system 130 or the mobile application on the mobile device 115 may determine whether the point total 240 of the user 110 has reached a point level 250 that needs to be reached in order for a prize to be awarded. As shown in FIG. 8, if it is determined that the point total 240 of the user 110 has reaches that point level 250 requirement, then a notification 810 may be presented to the user 110 indicating that the user 110 has been awarded a price, as well as indicating the next point level 250 that needs to be reached by the user 110 in order for a prize to be awarded. As shown in FIG. 9, the progress bar 260, the indication of the point total 240 for the user 110, and the indication of the point level 250 needed for the next prize may be updated to reflect the most current awarding of points to the user 110.

The health data system 130 contains innovations pertaining to dealing with an incoming stream of largely undifferentiated data and turning it into structured, sorted, annotated data that caregivers and experts can use to provide health recommendations and perform outreach to high-risk patients. In some embodiments, images will enter the health data system 130 from users (e.g., user 110) of the health data system 130. In some embodiments, some of these images will be annotated with some information about what they represent. The health data system 130 can have mechanisms for dealing with both annotated and unannotated data.

The health data system 130 can employ a combination of automation and human judgment to perform sorting and curation of the data derived from the user 110. Human judgment can be a primary input for this process. The human judgment can come in several forms. Another innovation of the present disclosure is the combination of full-time labor with crowd-sourced systems. Crowd-sourcing can be a highly efficient mechanism of performing repeated, structurally simple tasks at high volume and low cost. In some embodiments, the health data system 130 makes heavy use of backend crowd-sourcing to accomplish initial image categorization.

As previously discussed, one feature of the health data system 130 is to take an uploaded image and use it to update some set of structured data about the user 110 who uploaded it. This process may have several components.

In some embodiments, one component is that the image should be sorted according to what type of user information it represents. The health data system 130 can manage categories corresponding to each type of information (blood sugar reading, nutrition information, etc.), and the images may be sorted into the appropriate category. In some embodiments, some images will have already been annotated by the user 110 with their category, and these images can be sorted automatically.

In some embodiments, another component is that, within each category, there are several different subtypes of images. For example, for the category of blood sugar readings, images can be sorted into subtypes of fasting, pre-meal, or post-meal. As with the first step of sorting into categories, sometimes this information will be present in the annotations provided by the user 110, and sometimes it will need to be added by a system worker 140 on the backend.

In some embodiments, yet another component is that, once a photo has been assigned the correct subtype, any relevant health data it contains can be extracted, so that the extracted health data can be input as structured data of user health information into the database(s) 134. This process can be individualized for each category, and sometimes each subtype, of image. For example, blood sugar readings can be read off the image and input as numeric values. In some embodiments, some of the processes for particular subtypes of images can be fairly involved and might constitute innovative features in their own right. For instance, a sub-process of combining automatic judgments and human input to estimate the carbohydrate and calorie content of a meal represented in an image can be implemented, so that the health data system 130 can give the users feedback about their nutritional choices.

In some embodiments, yet another component is that, once the information has been stored as structured data, the health data system 130 can make it available to both patients and caregivers, as well as to others, such as family members and friends of patients. For patients, the features of the present disclosure will result in them obtaining a structured record of their health data without them having to engage in a laborious process of inputting different kinds of data in different specific ways. For caregivers, it will give them an intelligent view into the health of their patient population.

Additionally, the features disclosed herein help provide prompt notification to patients and those who have influence on the patients regarding information related to the health of the patients. Such notifications can notify the recipient(s) of a variety of things, including, but not limited to, a patient regularly uploading images of meals or meter readings, a patient not regularly uploading images of meals or meter readings, a patient adhering to nutritional guidelines, a patient not adhering to nutritional guidelines, a meter reading meeting certain standards, a meter reading being substandard, a patient adhering to exercise guidelines, and a patient not adhering to exercise guidelines. Effective outreach can be achieved by notifying nurses, family members, friends, or other patients in a group with the patient of important details related to the health of the patient. These other people can be prompted to reach out to the patient to encourage the following of certain health-related guidelines. Depending on the behavior prompting the notification, either positive reinforcement (e.g., words of encouragement, rewards, etc.), warnings, negative consequences (e.g., removal of rewards), or other social motivation can be incorporated into the notification process.

As previously mentioned, at each step of the data sorting and structuring process, a combination of automated and human labor can be used. In some embodiments, the main automation can rely on any user-added annotations. In some embodiments, other sorting can be performed using human labor, such as crowd-sourced labor in the context of custom-designed sorting workflows. Over time, machine learning algorithms can be employed to learn to distinguish different categories of images based on visual differences. Such machine learning algorithms can be used to implement automated categorization (and other processing) of images. For example, the machine learning algorithms can extract structured data from the images.

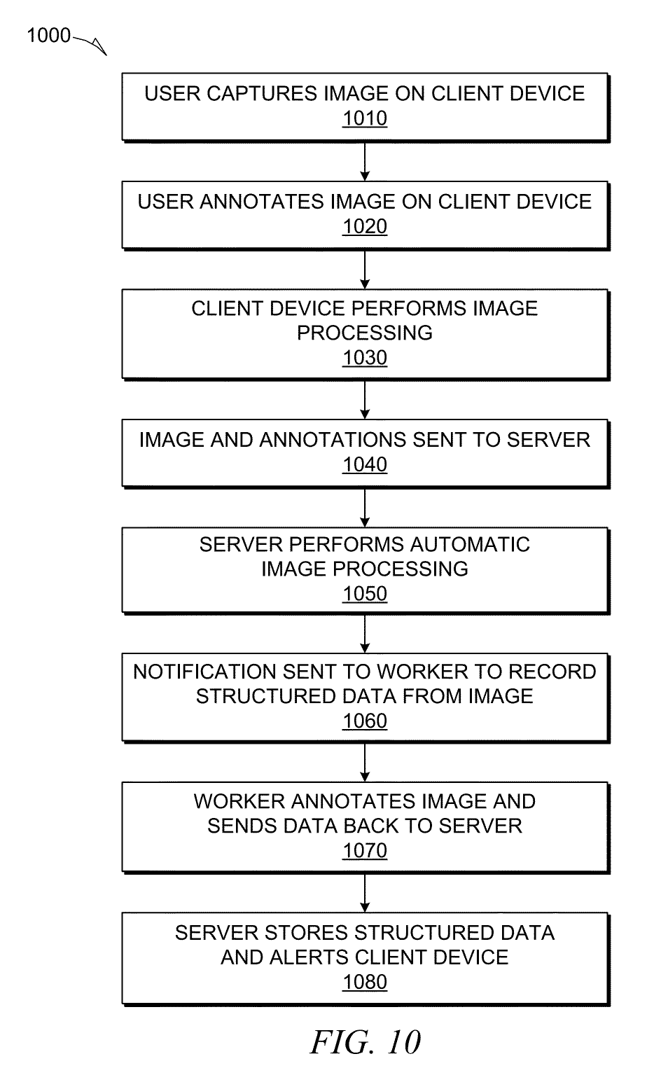

It is noted that the operations disclosed herein and with respect to the methods of FIGS. 10-18 discussed below may be performed by a variety of different devices or machines. Accordingly, operations described herein as being performed by a server or the health data module 132 on the health data system 130 can also be performed by a client or the mobile application on the mobile device 115, and operations described herein as being performed by a client or the mobile application on the mobile device 115 can also be performed by a server or the health data module 132 on the health data system 130. Additionally, it is contemplated that any of the other features described within the present disclosure may be incorporated into methods of FIGS. 10-18.

FIG. 10 is a flowchart illustrating a method 1000 of image processing, in accordance with an example embodiment. At operation 1010, the user 110 captures an image using a client device (e.g., mobile device 115). The user 110 can use a mobile application on the client device to open up a camera application that is used to take a picture. As discussed above, the image can comprise a variety of different things related to the health of the user 110, including, but not limited to, food, beverages, and health-related meter readings. At operation 1020, the user 110 annotates the captured image using the client device, thereby providing some data on the image. The annotations may comprise anything that enhances the information about the captured image, as previously discussed. At operation 1030, the client device may perform image processing on the captured image. In some embodiments, the client device may perform automatic image recognition on the captured image. Such image recognition can be used to identify distinct components in the captured image, such as what is in the image (e.g., is it food or a glucometer reading? If it is food, what kind of food?). In some embodiments, this image recognition and analysis can be used to provide annotation of the captured image in addition or as an alternative to the user-provided annotation. At operation 1040, the captured image and annotations are sent to the server (e.g., the health data system 130).

At operation 1050, subsequent to receiving the captured image and annotations from the client device, the server performs automatic image processing using the received captured image and annotations. Here, the server can use stored information and intelligence about other similar images in order to derive information about the current image. For example, the server may have access to a library of images of food, beverages, and health meter readings that are stored in a database (e.g., database 134). The server can perform a comparison analysis of the captured image and the stored information to determine more detailed information about the contents of the captured image. In some embodiments, the server may determine similarity between the contents of the captured image currently at issue and the contents of stored images based on information indicating where and when the images were captured. For example, images that are known to be captured in the morning are more likely to represent breakfast food, and images that are known to be taken in a particular restaurant can be determined to be of food provided by that particular restaurant.

At operation 1060, a notification can be sent (e.g., pushed) to a system worker 140 to record structured data from the captured image. For example, a notification can be pushed to a nutritionist instructing the nutritionist to perform one or more particular actions. At operation 1070, the system worker 140 can provide annotation for the image. In some embodiments, if the image comprises a glucometer reading, then optical character recognition can be used to determine the numerical reading in the image. In some embodiments, if the image comprises food, then the system worker 140 can separate the food into different types and create bounding areas (e.g., boundary boxes) in the image, determine what kind of food is in each bounding area, and determine the portion size of food for each bounding area. The system worker 140 can provide this information to the server, which can then perform a lookup using this information to calculate nutritional information, such as calories, carbohydrates, fats, and sugars. The annotations provided in operation 1070 (and in operation 1020) can form structured data. At operation 1080, the server can store the structured data in association with the corresponding user, and can send a push notification back to the client device indicating that the uploaded image has been processed and providing information derived from the image (e.g., nutritional information, an analysis of how well the user is adhering to nutritional guidelines, etc.). The user will then be able to view this real data on the client device, as opposed to merely a captured image. The server can also send the structured data elsewhere. For example, the server can send the structured data to other backend systems or components, caregivers of the user, family members of the user, friends of the user, and electronic medical record systems.

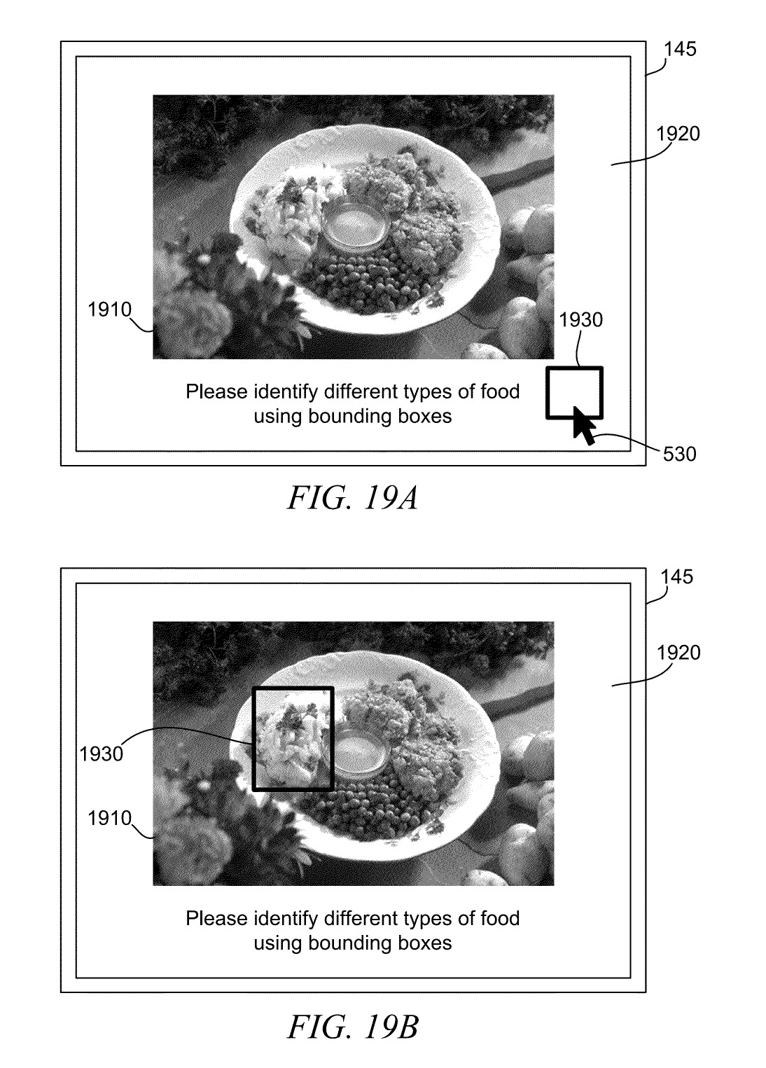

FIGS. 19A-19B illustrate a graphical user interface 1920 on a computing device 145 being used by a system worker 140 to identify different types of food on a plate, in accordance with example embodiments. The system worker 140 can size and place bounding boxes 1930 over different types of food in an uploaded image 1910. As seen in FIGS. 19A-19B, the system worker 140, using a pointer 530, can move a bounding box 1930 around the food to be identified. It is contemplated that other ways of moving and sizing the bounding box 1930 other than the use of the pointer 530 can be employed. Furthermore, shapes other than boxes can be used as the bounding areas for separating and identifying the different types of food in the image 1910.

The health data system 130 can be used to determine and adjust patient engagement approaches for different users. Some patients engage with the services of the health data system 130 less than others. As a result, a more robust engagement approach (e.g., more incentives, more notifications to them or their family members) may be appropriate. The idea is to determine and analyze how well a patient is engaging with his or her treatment regimen, and then adjust the engagement approach based on the analysis.

In some embodiments, the health data system 130 can manage different user experiment groups, with different engagement techniques being used across different groups of users in order to understand which engagement techniques are the most effective. For example, if there are one-hundred users, the health data system 130 can divide these one-hundred users into ten different user experiment groups, with each user experiment group having its own distinct engagement technique. The health data system 130 can monitor the activity or results of the users, analyze or compare the activity or results of the different user experiment groups, and then adjust engagement approaches or treatments accordingly. In some embodiments, the health data system 130 can automatically adjust experiment groups and engagement approaches based on the activity or results of the different user experiment groups or on other information about user activity. In some embodiments, the health data system 130 can present this information to system workers and enable them to make adjustments to experiment groups and engagement approaches.

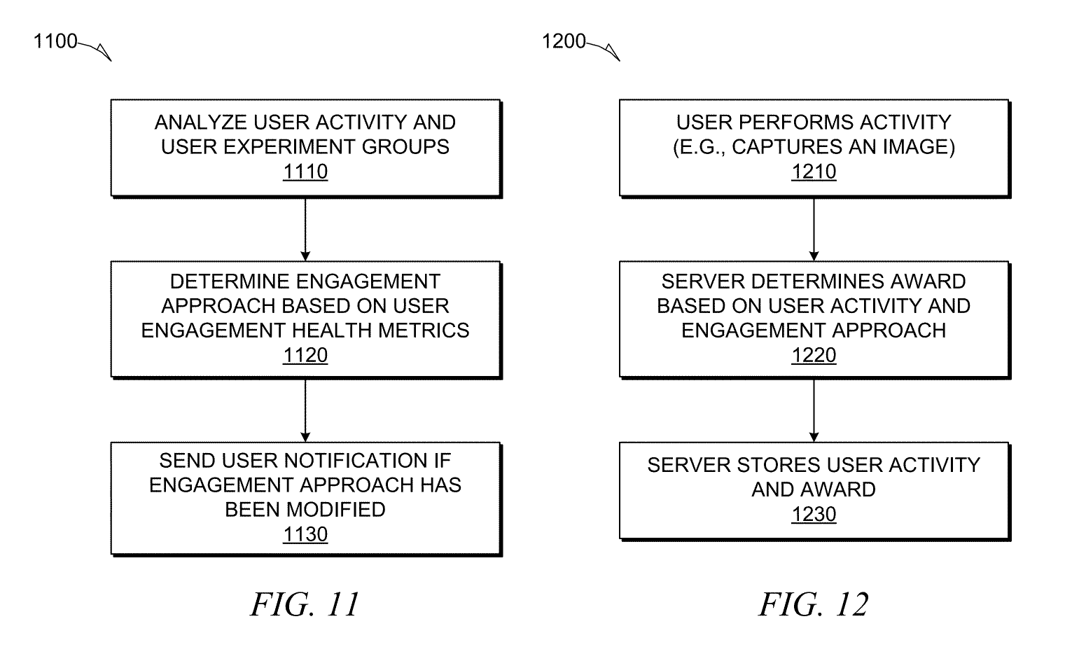

FIG. 11 is a flowchart illustrating a method 1100 of determining an engagement approach, in accordance with an example embodiment. In some embodiments, the health data system 130 can manage different user experiment groups, with different engagement techniques and strategies (also referred to as “interventions” within the present disclosure) being used across different groups of users in order to understand which engagement techniques and strategies are the most effective. At operation 1110, the health data system 130 can analyze user activity across different user experiment groups. As previously discussed, the health data system 130 can examine the activity of the users and how the users have responded to the different engagement/incentive strategies, thereby determining user engagement health metrics. At operation 1120, the health data system 130 can determine the optimal engagement/incentive strategies based on the determined user engagement health metrics. In this fashion, the health data system 130 learns what the optimal engagement approach is based on updated information about how the users are responding to the different engagement approaches. At operation 1130, if an engagement approach for a user experiment group has been modified, then the health data system 130 can then send a notification of this modification to the users in that user experiment group. For example, if a user is not engaging as fully as he or she should, the health data system 130 can push a notification that informs the user that he or she will win an extra five dollars for the next photo that he or she takes and uploads. This notification engages the users to tell them that something has changed, thereby increasing the likelihood that they will change their behavior accordingly.

If the health data system 130 determines that engagement approach A is not working for a first group of users, but determines that engagement approach B is working for a second group of users, then the health data system 130 can change the engagement approach for the first group of users to engagement approach B, and then notify the first group of users of that change. In some embodiments, the health data system 130 can assign an expiration date to the engagement approach and notify the group of users of the expiration date in order to motivate them to augment their behavior promptly.

FIG. 12 is a flowchart illustrating a method 1200 of implementing an engagement approach, in accordance with an example embodiment. At operation 1210, the user 110 performs an activity using the mobile device 115. For example, the user 110 can capture and upload an image of a meal using the mobile device 115. At operation 1220, after receiving an indication of the user activity (e.g., receiving the uploaded imaged), the server can determine an award (e.g., points, money, coupons, information, etc.) based on an analysis of the user activity and a determined engagement approach for the user. At operation 1230, the server stores the user activity and award (e.g., in database(s) 134) in association with the user 110. This stored information can subsequently be used to determine engagement approaches, such as discussed above with respect to method 1100 in FIG. 11.

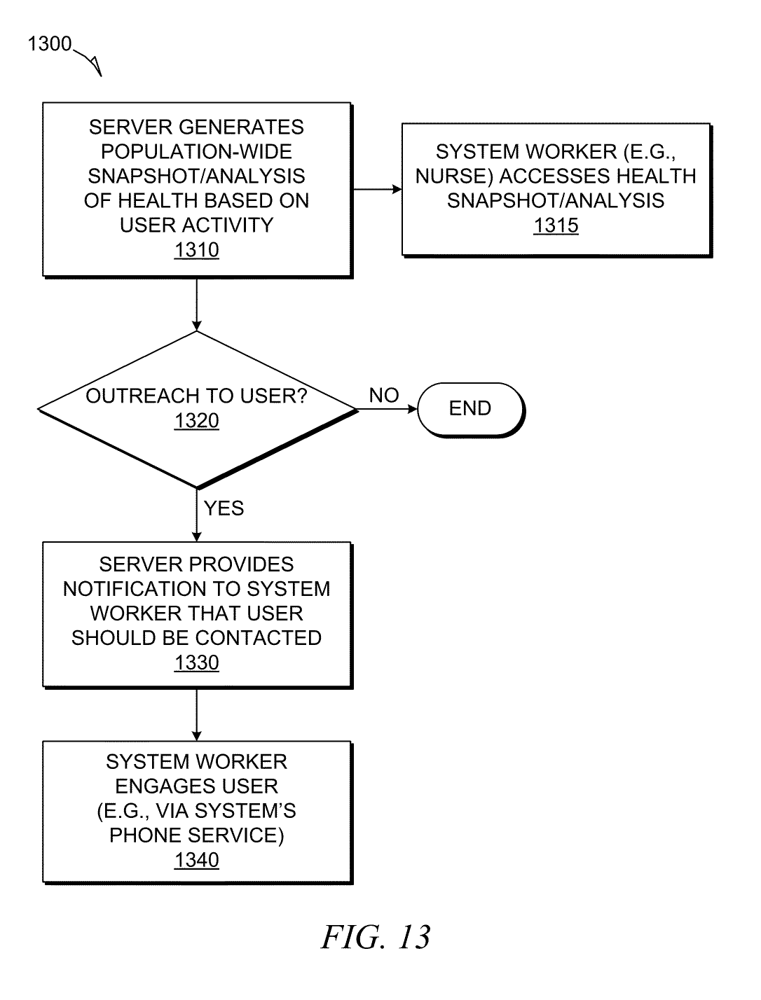

FIG. 13 is a flowchart illustrating a user outreach method 1300, in accordance with an example embodiment. At operation 1310, the server generates a population-wide snapshot analysis of health by examining the user activity and health metrics for users in order to figure out how users are doing across the board. At operation 1315, a system worker 140 can access this snapshot analysis of health for users associated with the system worker 140. For example, a nurse can access a snapshot analysis of health for all of the nurse's patients. This analysis can comprise statistical information regarding the health of her patients (e.g., 10% of the nurses patients are not exercising enough). The server can provide a notification recommending the system worker to take action based on this analysis.

At operation 1320, the server determines whether or not outreach to a user should be recommended. This determination can be made based on information about the user's activity, health status, current engagement approach, the engagement approach of other users, and other information stored in the database(s) 134.

If it is determined that outreach to the user should be recommended, then, at operation 1330, the server provides a notification to the system worker 140 that the user should be contacted. For example, it may be determined that, based on a user's blood sugar level being above 300 mg/dL for the past 48 hours, something has gone wrong with the user's health and that a nurse should contact the user. Accordingly, the server can notify the nurse of this situation and recommendation based on this determination.

At operation 1340, the system worker 140 can engage the user. In some embodiments, the system worker 140 can contact the user using a phone service provided by the health data system 130. For example, the system worker 140 can call a middle line that will call up the user and track and store information about the conversation (duration, content, etc.). This information can be stored in the database(s) and subsequently fed back into and used in the user engagement determination process. In some embodiments, the health data system 130 can perform outreach directly using automated methods without employing the system worker's time or effort. For example, the the health data system 130 can automatically send an e-mail or text message to a patient or a family member of the patient in response to a determination that the user's blood sugar level has been high for the last two weeks or that the patient has not been uploading images of meals. The notification can comprise information about what has prompted the notification, such as the patient not following a prescribed regimen.

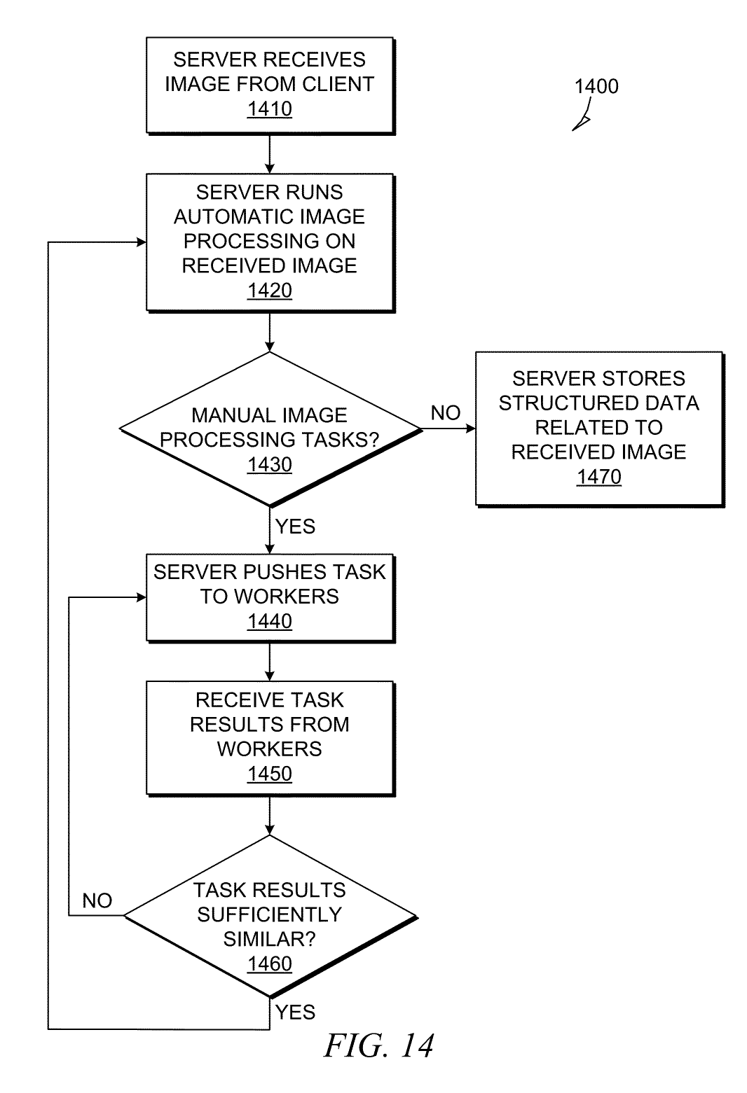

FIG. 14 is a flowchart illustrating another method 1400 of image processing, in accordance with an example embodiment. At operation 1410, the server receives an image uploaded from the client device. At operation 1420, the server runs automatic image processing on the received image. This automatic image processing may comprise making determinations based on annotations provided by the user on the client device. For example, the server may determine based on one or more annotations that the image is of the user's dinner.

At operation 1430, the server can determine if there are any manual image processing tasks to be performed. This determination may be based on information determined from the automatic image processing. For example, if it has been determined that the image is of the user's dinner, then the server may determine that a certain number of manual image processing tasks should be performed based on that determination. If it is determined that no manual image processing tasks should be performed, then, at operation 1470, the server stores the structured data about the received image, such as the annotations provided by the user and timestamp information that indicates when the image was taken.

If it is determined at operation 1430 that one or more manual image processing tasks should be performed, then, at operation 1440, the server pushes the task(s) to system workers. In order to ensure accuracy of the manual image processing, the tasks can be pushed to multiple system workers.

At operation 1450, the server can receive the task results from the system workers. At operation 1460, the server can determine whether or not the task results of the system workers are sufficiently similar to one another. If it is determined that the task results are not sufficiently similar, then the server can interpret this inconsistency as an indication of inaccuracy in the performance of the task by the system workers. As a result, the server can push the task to a different set of workers at operation 1440. If it is determined, at operation 1460, that the task results are sufficiently similar, then the method may return to operation 1420, where the server performs automatic image processing on the image again, but now with the task results being provided as annotations. This flow can be repeated until there are no more manual image processing tasks left to be performed. At that point, the server can store the structured data of the image at operation 1470. Here, the structured data can include the task results or a summary of the task results.

In one example, the server may receive an image of food from the client. In response to the determination during the automatic image processing that the image is of food, the server can push a first manual image processing task to the queue of three different system workers. This first manual image processing task may be to identify the different types of food in the image using bounding boxes, as previously discussed. The server can then wait for the responses (task results) of the system workers. The server can determine if the system workers' identification of the different types of food in the image are sufficiently similar (e.g., whether the three system workers identified roughly the same number of types of food in roughly the same areas of the image). If the bounding boxes of the three different workers are sufficiently similar, then the server can return to performing automatic image processing, taking the bounding boxes from the three workers and averaging them out, resulting in an image of averaged bounding boxes.

The next manual image processing task may then be to determine what type of food is in each bounding box (e.g., chicken, mashed potatoes, peas, etc.). This task is once again pushed by the server to the three different system workers. Upon receiving the task results from the system workers, the server determines if they are sufficiently similar (e.g., did the three system workers identify/label the food in the bounding boxes the same). If the task results are sufficiently similar, then the server can once again perform automatic image processing, converting the task results (e.g., the identification of the food in the bounding boxes) into structured data.

The next manual image processing task may be to determine how much of each type of food is in the bounding boxes. This task is pushed to the three different system workers. After receiving the task results from the system workers, the server determines if they are sufficiently similar (e.g., did the system workers agree on the portion size of food in each bounding box). The server can make this determination based on a threshold level of similarity (e.g., the corresponding portion sizes provided by each system worker being within a certain amount of one another). If these task results are sufficiently similar, then the server can once again perform automatic image processing, averaging the portion sizes provided by the system workers for each bounding box, and then associating these average portion sizes with the image and the identified food types in the image.

When the server determines that no other manual image processing tasks should be performed, then the server can determine information about the image based on the task results. For example, based on the identification of what kind of food is in the image and the determined average portion size of each kind of food, the server can determine nutritional information about the food in the image, such as by accessing a lookup table. This nutritional information can then be stored as structured data associated with the user that uploaded the image.

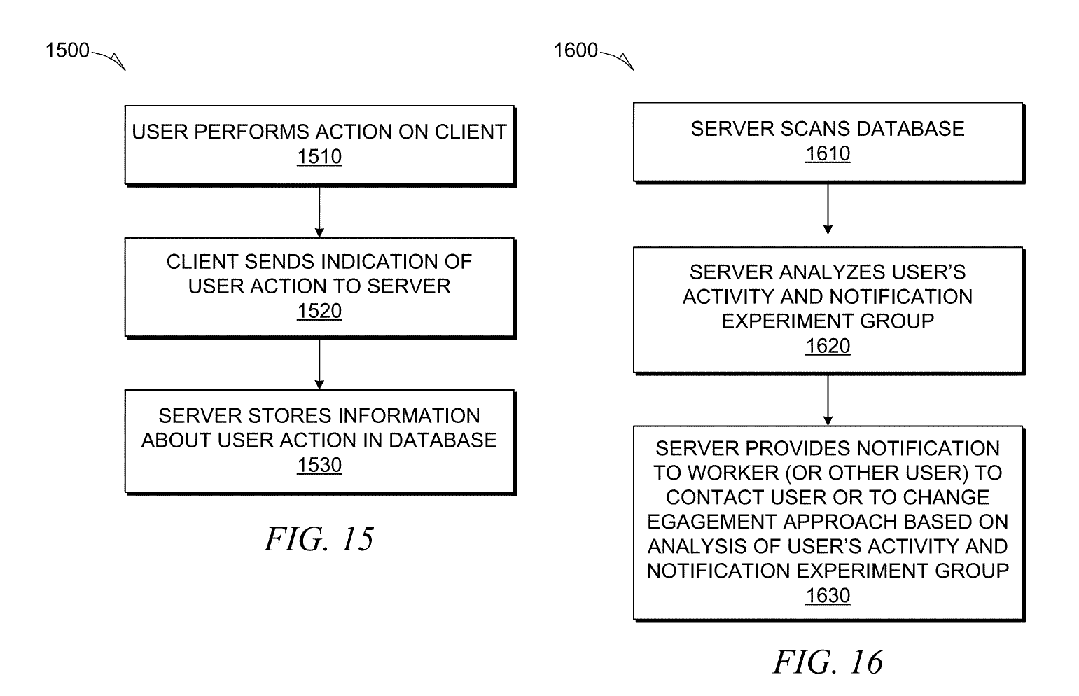

FIG. 15 is a flowchart illustrating a method 1500 of maintaining a history of user activity, in accordance with an example embodiment. At operation 1510, the user 110 performs an action on the client device. In some embodiments, the action comprises capturing an image. At operation 1520, the client device sends an indication of the user action to the server. In some embodiments, the indication comprises a captured image. At operation 1530, the server stores information about the user action in the database 134. By continuously receiving and storing information about the user's actions, the server can maintain a log of the user's activity for subsequent processing and analysis.

FIG. 16 is a flowchart illustrating a method 1600 of providing a notification, in accordance with an example embodiment. In method 1600, the server can analyze the information about the user's activity and the user's notification experiment group, and then provide a notification based on this analysis. At operation 1610, the server scans the database to retrieve information about the user's activity. This information can include the structured data extracted from the images that have been uploaded by the user. At operation 1620, the server analyzes the user's activity and the user's notification experiment group. The analysis can involve a determination of whether the user's activity is adhering to a particular regimen, how effective the engagement approach for the user is, whether the engagement approach for the user should be changed, and how to change the engagement approach for the user. In some embodiments, the server compares the user activity from one experiment group to another in order to determine which experiment groups are performing better, and therefore, which engagement approaches are working better. At operation 1630, the server can provide a notification to a system worker (e.g., a nutritionist or a nurse) to contact the user based on the analysis, such as to provide counseling, information, or motivation for the user. In some embodiments, the notification can be provided to another user in the same group as the user, or to a family member or friend of the user. In some embodiments, the server provides a notification to the system worker to change the engagement approach for the user. In some embodiments, the server can present the information about the user's activity, retrieved at operation 1610, to the system worker. The system worker can then analyze the information and make a determination about whether the user's activity is adhering to a particular regimen, how effective the engagement approach for the user is, whether the engagement approach for the user should be changed, and how to change the engagement approach for the user. The server can enable the system worker to implement any changes to the engagement approach that the system worker has determined should be made, such as via a user interface. Accordingly, the assessment and/or implementation of an engagement approach can be performed automatically by the server or via direction by the system worker.

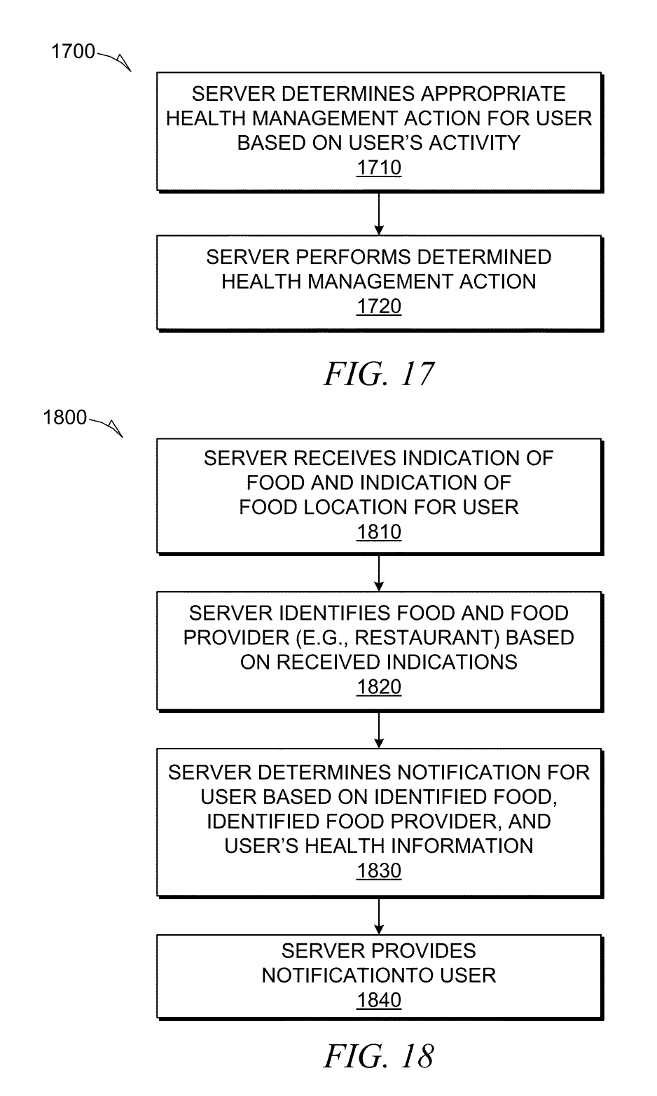

FIG. 17 is a flowchart illustrating a method 1700 of providing health management services, in accordance with an example embodiment. At operation 1710, the server determines one or more appropriate health management actions for the user based on an analysis of the user's activity. The health management actions may comprise any of the types of services discussed herein, such as notifying the user of non-adherence with a regimen or of poor heath indicators, notifying an interested party (e.g., nurse, family member, friend, other user in the same group) of the user's non-adherence with a regimen or of poor health indicators, changing of an engagement approach for the user, notifying the user or another interested party of a change in the engagement approach for the user, or providing health-related information (e.g., medical information, nutritional information, etc.). At operation 1720, the server performs the determined health management action.

One of the features of the present disclosure is to provide real-time analysis of meals. A user sitting down for a meal can take a picture of a plate of food, and upload the picture to the health data system, which can process the uploaded image and determine nutritional information for the plate of food. The health data system can then send back information to the user regarding the plate of food. Such information can include, but is not limited to, the nutritional information of the plate of food and a warning that consuming the plate of food will cause the user to violate a dietary regimen assigned to the user (e.g., “You are about to exceed your calorie count and carbohydrate count for the day!”).

The real-time analysis of food can be extended to situations where the user is dining in a restaurant or a location of some other food provider (e.g., a market). In some embodiments, the user's GPS location may be determined from the user's mobile device. The restaurant can be identified using the GPS location, and reference data on the food (e.g., nutritional information) can be accessed based on an identification of the restaurant. The user's health information can be accessed and used along with the reference data on the food to generate and provide recommendations, advice, or other health-related information to the user regarding the food.

FIG. 18 is a flowchart illustrating a method 1800 of providing real-time health-related information regarding food, in accordance with an example embodiment. At operation 1810, a server receives an indication of food (e.g., an image of food) and an indication of a food location (e.g., a GPS location) for the user. At operation 1820, the server identifies the food, based on the indication of food, and a food provider, based on the indication of the food location. At operation 1830, the server generates a notification for the user based on the identified food, the identified food provider, and the user's health information. At operation 1840, the server provides the notification to the user.

As previously discussed, one of the features of the present disclosure is to generate structured data from a captured image. This structured data can then be used in a variety of ways. In some embodiments, an automatic analysis of what people are doing can be performed using the structured data in order to give them suggestions (e.g., dietary recommendations, exercise recommendations, etc.) for how to improve based on analyses of what tends to work well. In some embodiments, the structured data can be used to provide integrative services with an electronic medical records system, such as reminders for doctor visits. The structured data can also be used to provide integrative services with pharmacies. For example, the health data system can determine based on an image of a pill container that the user only has two pills left, automatically notify the user of the low supply, and prompt the user to refill the prescription by clicking on a link.

In some embodiments, the health data system can provide a guessing game for users, enabling the users to rate how well they think they are adhering to a prescribed regimen or to test their knowledge of the nutritional content of what they are consuming. For example, a user may guess how many calories and carbohydrates are in the user's meal. The user's guess may be compared to the actual caloric and carbohydrate amounts derived from a captured image of the meal uploaded by the user. The user may then receive feedback about the accuracy of his or her guess (e.g., how close or how far off from the actual amounts). The user may be awarded points or prizes for accurate guesses. If the user shows a pattern of guessing incorrectly or being wildly incorrect, then an interested party (e.g., a nurse or family member) may be automatically notified of the user's lack of knowledge regarding nutritional information.

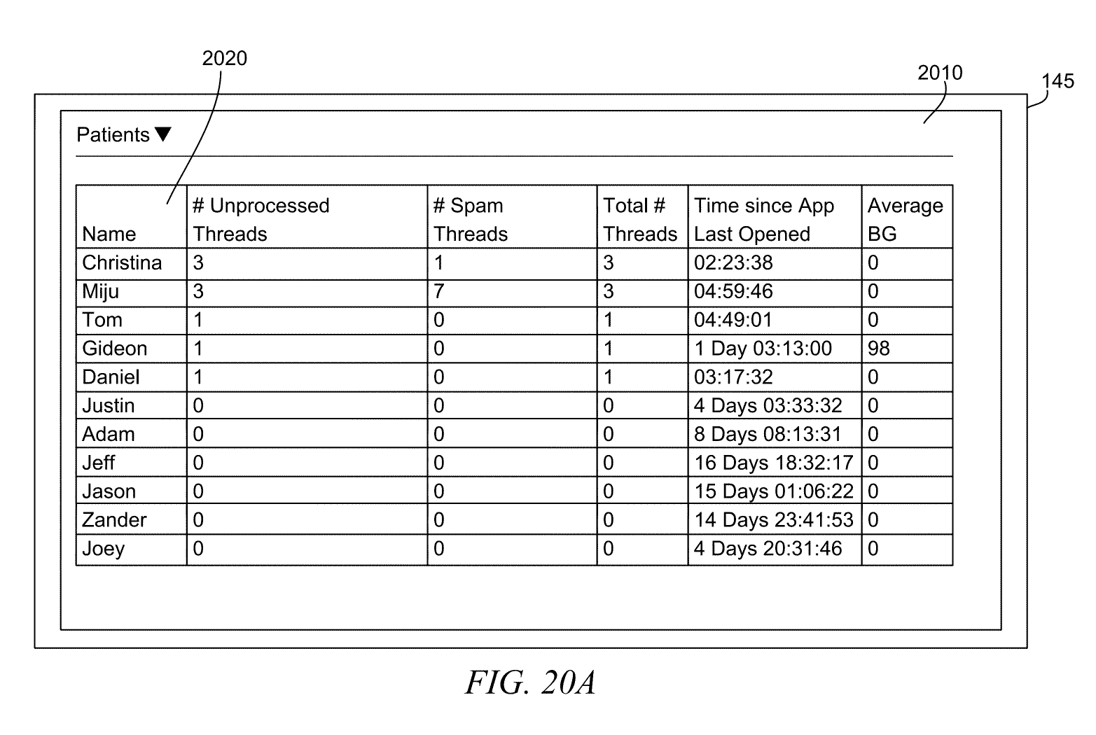

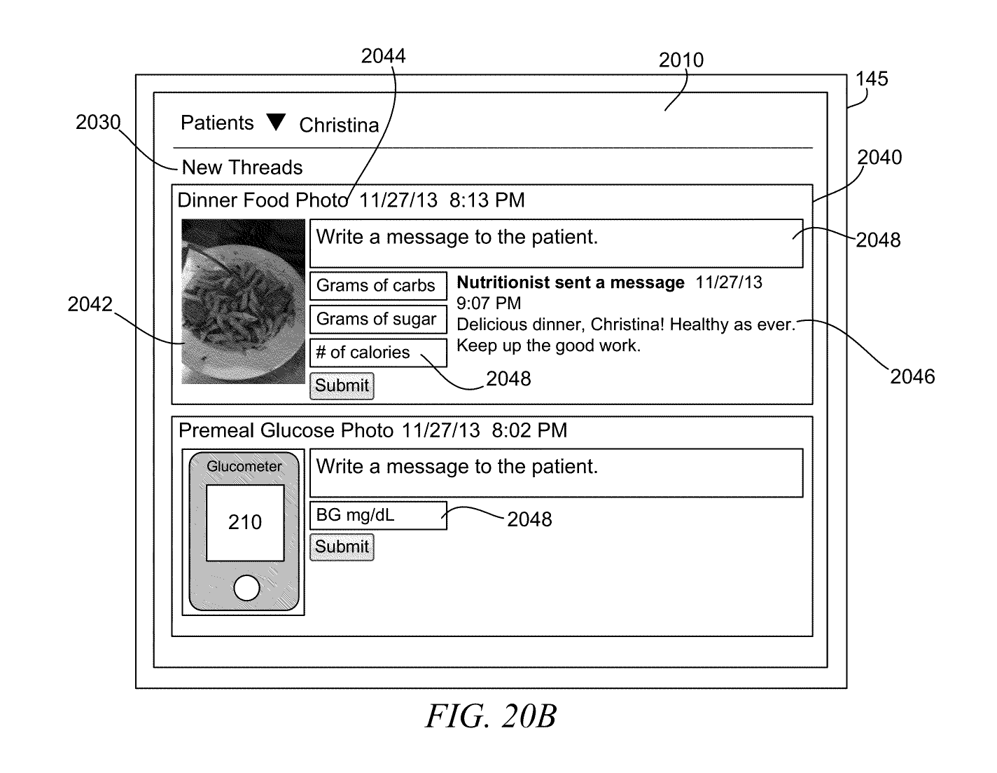

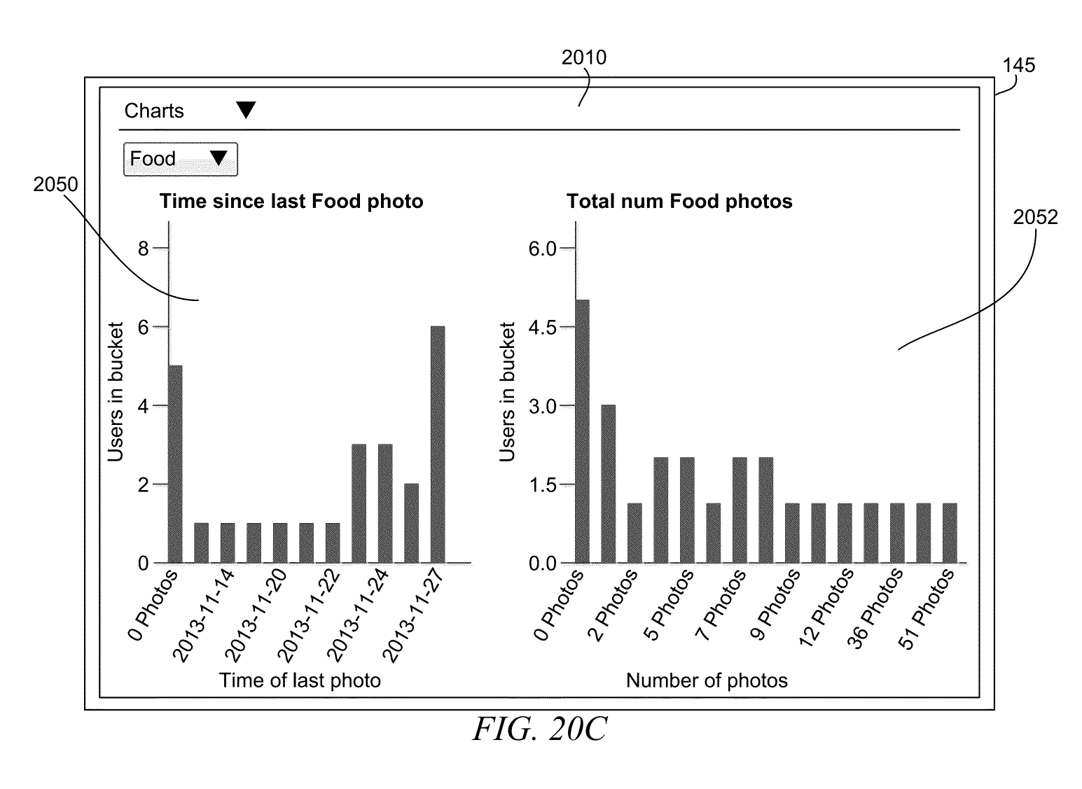

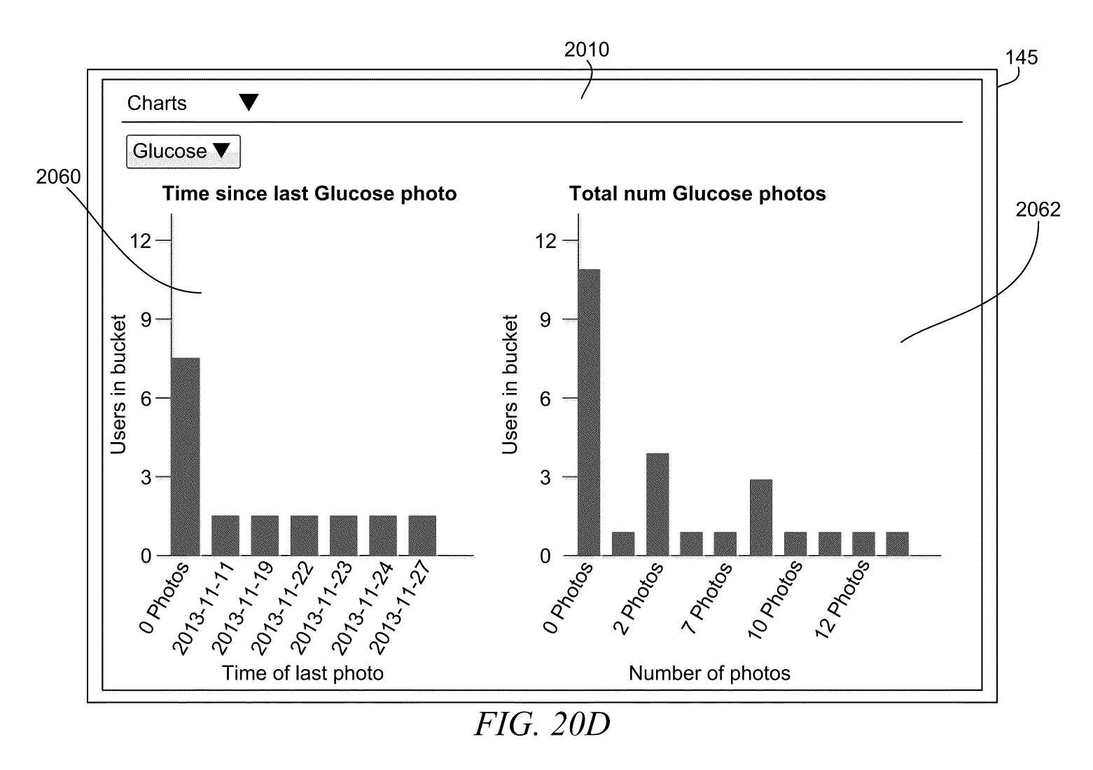

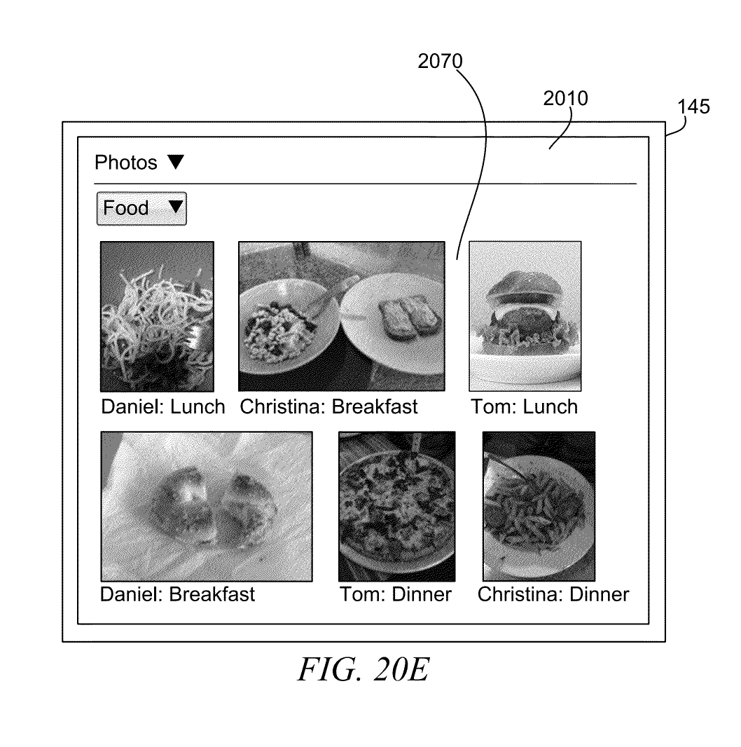

FIGS. 20A-20E illustrate a graphical user interface 2010 on a computing device 145 being used to manage health-related data of patients. The graphical user interface 2010 can be used by system workers 140 for backend management of health-related data of patients, as well as for patient outreach.

In FIG. 20A, the graphical user interface 2010 presents an overview dashboard with a list 2020 of all relevant patients for a particular system worker 140. The list 2020 can also include information about how much data the patients have uploaded recently and an indication of what data still has not been processed by the system worker 140. In some embodiments, the graphical user interface 2010 may provide a way of triaging patients into different categories, such as one category for patients that need outreach (e.g., manual intervention) and another category for patients that do not need outreach. In some embodiments, the list 2020 can be presented in the context of a notification or message inbox. As will be discussed in further detail later in the disclosure, elements of the list 2020, such as the patients, can be prioritized. For example, a corresponding priority value can be determined for each patient in the list 2020 based on any combination of one or more priority factors, which will be discussed in further detail later. The presentation of the list 2020 can then be based on the priority values. For example, the priority values of the patients can be displayed, indicating in what order the system worker should review or address the patients. In another example, the patients in the list 2020 can be displayed based on a ranking of their priority values, with the patients with the highest priority values at the top and the patients with the lowest priority values at the bottom.

In some embodiments, the system worker 140 can view a patient-specific stream of the data a particular patient has uploaded, such as by selecting (e.g., clicking) one of the patient names in the list 2020. In FIG. 20B, the graphical user interface 2010 presents a per-patient stream 2030 that displays all of the data the selected patient (e.g., Christina) has uploaded. In some embodiments, the most recently uploaded data can be displayed first (e.g., closest to the top). The stream 2030 can comprise a series of upload entries 2040, with each upload entry comprising information about the corresponding uploaded data. In some embodiments, each upload entry 2040 can comprise images (e.g., an image 2042 of a meal or a glucometer reading) and annotations 2044 (e.g., an identification of the image content, such as “Dinner Food Photo” or “Premeal Glucose Photo”, a time/date stamp for the image). Each upload entry 2040 can also include a conversation area 246 where conversations between the corresponding patient and system worker 140 can be displayed. The system worker 140 can send feedback straight to the patient's device using one or more input fields 2048. The system worker 140 can use these one or more input fields 2048 to write a message to the patient, which can then be displayed in the conversation area 2046, or to annotate an uploaded image, such as with nutritional information (e.g., grams of carbohydrates, grams of sugar, number of calories) or meter reading information (e.g., blood glucose level in mg/dL). Any of this information submitted by the system worker 140 can then be processed as structured data, which can then be stored in the health data system 130 and sent, displayed, or otherwise provided, to interested parties (e.g., the corresponding patient, family members, caregivers) as appropriate. In some embodiments, unprocessed user data and communications can be highlighted in order to be brought to the attention of the system worker 140.

In some embodiments, the graphical user interface 2010 can also provide analytical and/or statistical information about the behavior or activity of patients of a system worker 140. The health data system 130 can determine this analytical and/or statistical information based on an analysis of the structured data obtained from the users 110 and/or the system workers 140. In one example shown in FIG. 20C, the graphical user interface 2010 displays a chart 2050 showing buckets corresponding to the amount of time that has passed since the last food photo upload and the number of patients of the system worker 140 that fall into each bucket (e.g., 5 users have uploaded 0 photos of food, 1 user uploaded a photo of food on 2013 Nov. 14, 3 users uploaded a photo of food on 2013 Nov. 24, and 6 users uploaded a photo of food on 2013 Nov. 27). The graphical user interface 2010 can also display a chart 2052 showing buckets corresponding to the number of photos of food uploaded and the number of patients of the system worker 140 that fall into each bucket. It is contemplated that other types of charts, as well as other types of analytical and statistical information, can be generated by the health data system 130 and displayed to the system worker 140. The system worker 140 can then use this information to analyze the effectiveness of and modify engagement approaches for different sets of patients.

In FIG. 20D, the graphical user interface 2010 displays a chart 2060 showing buckets corresponding to the amount of time that has passed since the last glucose-related photo upload and the number of patients of the system worker 140 that fall into each bucket (e.g., 3 users uploaded a photo of a glucose reading on 2013 Nov. 23, 4 users uploaded a photo of a glucose reading on 2013 Nov. 27, etc.). The graphical user interface 2010 can also display a chart 2062 showing buckets corresponding to the number of glucose-related photos uploaded and the number of patients of the system worker 140 that fall into each bucket (e.g., 11 users uploaded 0 photos, 1 user uploaded 7 photos, 1 user uploaded 10 photos, 1 user uploaded 12 photos, etc.). It is contemplated that other types of charts, as well as other types of analytical and statistical information, can be generated by the health data system 130 and displayed to the system worker 140. The system worker 140 can then use this information to analyze the effectiveness of and modify engagement approaches for different sets of patients.

In some embodiments, the health data system 130 can generate analytical and/or statistical information corresponding to a particular patient, and then present this information to the patient. For example, the health data system 130 can generate a graph showing the patient's blood sugar level over a certain period of time, and display this graph to the patient. In another example, the health data system 130 can generate a graph showing the correlation between the patient's blood sugar level and patient's carbohydrate intake, and display this graph to the patient. In yet another example, the health data system 130 can provide information to the patient regarding how the patient's behavior or activity compares to other patients (e.g., “You have uploaded 70% more photos than other patients. Good Job!”).

In FIG. 20E, the graphical user interface 2010 can display a series 2070 of photos that have been uploaded by the patients of a particular system worker 140, with each photo having a corresponding identification, such as the name of the corresponding patient and an identification of the content in the photo. In FIG. 20E, the series 2070 of photos comprise photos of food that have been uploaded by the patients of the system worker 140. It is contemplated that other categories of photos, such as glucose readings, can also be displayed. By presenting the uploaded photos to the system worker 140 in this fashion, the system worker 140 can acquire a visual understanding of how patients as a whole are behaving, as well as visually identify patterns or trends among patients.

Referring back to the problems health care providers often encounter, health care providers often wish to offer support of various kinds for patients suffering from chronic illnesses. This support is often designed in the form of an intervention. Examples of interventions include, but are not limited to, an in-person diabetes education curriculum, monthly phone calls from a coach or nurse to check in about recent blood glucose levels, a packet of printed materials delivered to the patient's home by mail, subsidies for medical supplies, or a complex coaching experience delivered via a smartphone app. Interventions can be combined for different patient populations.

These interventions can be offered via various outreach channels. Outreach channels include, but are not limited to, in-person visits with a provider, telephone calls, short message service (SMS) messages, multimedia message service (MMS) messages, communication via a smartphone app, email exchanges, and a patient web portal.

Today, providers typically implement interventions specific to one of these channels. This process is time-consuming and expensive, and requires customization whenever a provider wants to offer a new form of support or expand their support to a new channel. The features of the present disclosure provide solutions to this problem, including, but not limited to, prioritized coach notifications and automatic channel optimization, which will both be explained in further detail later.

Today, when a provider is designing an intervention, coaches and other support staff must be trained in the entire new workflow of the intervention. The support staff can include non-coach staff at the health care provider, the patient's family, and the patient themselves.

In one example, part of the workflow for enrolling patients in an in-person diabetes education program might be: (1) call a patient who has not yet been enrolled in the program; (2) read information from a script designed to encourage the patient to sign up; (3) if they decline, put them on a list to try again in six months; (4) if they accept, put them on the active patient list; and (5) for patients on the active patient list, call them once a week and inquire about their recent blood glucose levels and the amount of exercise they were able to do that week.

In order to execute an intervention, coaches and support staff often must learn not only the content of the intervention (e.g., what kind of diabetes coaching support to offer, how to do a finger stick, how to help a loved one deal with low blood sugars), but also the entirety of the workflows and rules involved in when and how to deploy the intervention (motivational interviewing techniques, how to interpret your blood glucose readings and when to check them, and the 15/15 rule).

With the system of prioritized coach notifications disclosed herein, coaches can be trained to respond to a set of notifications that are presented consistently in a specialized UI. Thus, rather than learn a whole workflow start-to-finish, coaches instead learn what to do when the system displays a notification asking them to perform one of a predetermined set of actions (e.g., send the patient a message asking about their weekend, evaluate the patient's recent blood glucose values and record a summary to send to the patient, etc.).

This shift allows the system to define and simultaneously experiment with many different interventions, without the coaches needing to be aware of any complex protocols of any particular intervention in their entirety. This improvement dramatically reduces the overhead involved in experimenting with different interventions, allows the same coaches to efficiently and seamlessly transition from working within one intervention to working within a different one, and allows interventions to become more complex. Additionally, the system enables system workers to analyze user activity data, evaluate engagement approaches, and adjust engagement approaches.

Finally, the notifications that a given coach sees at any given moment can be prioritized according to the urgency of the action for the particular patient. The prioritization can be calculated based on a number of factors, including but not limited to, the type of notification, the user's current health status, the user's past engagement on the platform, the interventions that a particular user is part of, and how busy the coach currently is. Placing all outstanding notifications on a single consistent priority scale allows the tool of the present disclosure to present a simple UI for the coach, where the best order for the coach to go through their patients is clear.

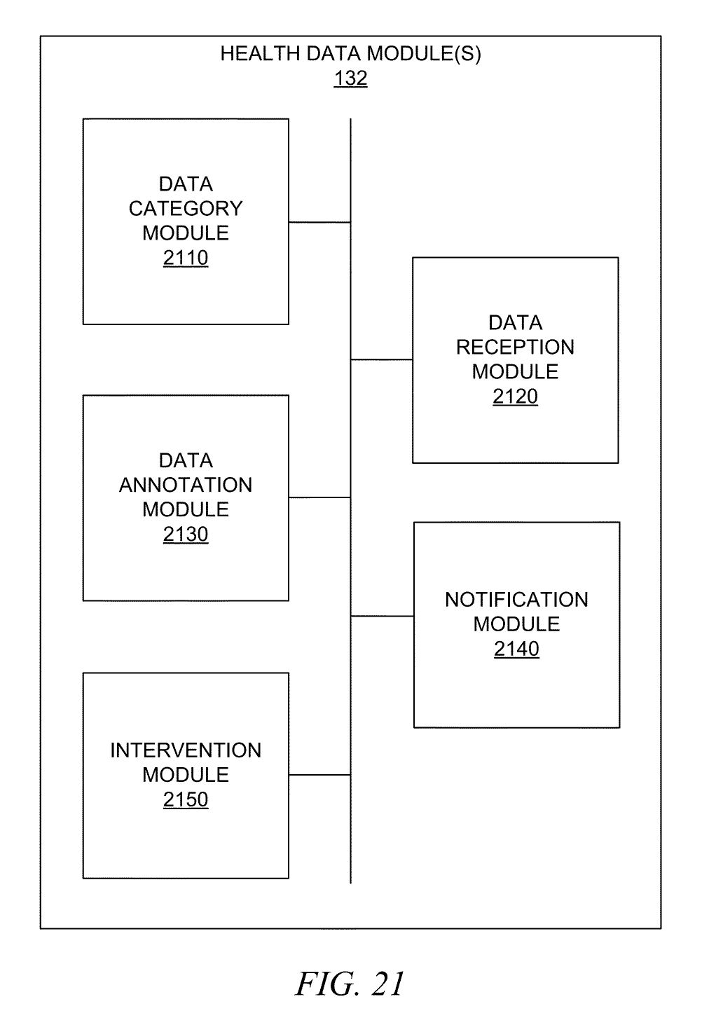

FIG. 21 is a block diagram illustrating health data module(s) 132, in accordance with some example embodiments. In some example embodiments, the health data module(s) 132 can comprise any combination of one or more of a data category module 2110, a data reception module 2120, a data annotation module 2130, a notification module 2140, and an intervention module 2150. The modules 2110, 2120, 2130, 2140, and 2150 can reside on a machine having a memory and at least one processor (not shown). In some example embodiments, these modules 2110, 2120, 2130, 2140, and 2150 can be incorporated into health data system 130 in FIG. 1 (e.g., one or more servers separate and remote from the mobile device 115). As previously discussed, although health data module(s) 132 are shown in FIG. 1 as residing within health data system 130, separate and remote from the mobile device 115, it is contemplated that any combination of one or more of the health data module(s) 132 can reside wholly or partially on the mobile device 115. Any combination of the modules 2110, 2120, 2130, 2140, and 2150 can be combined into a single module.

The data category module 2110 can be configured to cause a first plurality of selectable UI elements (e.g., selectable user interface elements 220 and 230 in FIG. 2) to be displayed on a mobile device. Each one of the first plurality of selectable UI elements can indicate a distinct image category. The first plurality of selectable UI elements can comprise a first selectable UI element indicating a food image category for food data and a second selectable UI element indicating a measurement image category for medical device measurement data. The data category module 2110 can also be configured to receive a user selection of one of the first plurality of selectable UI elements.

The data reception module 2120 can be configured to receive image data (e.g., captured image 325 in FIG. 3, captured image 425 in FIG. 4) captured by an image capture device on the mobile device (e.g., as disclosed herein with respect to FIGS. 2-4).

The data annotation module 2130 can be configured to determine a second plurality of selectable UI elements (e.g., selectable interface elements in image annotation area 340 of FIG. 3, selectable interface elements in image annotation area 440 in FIG. 4) to be displayed on the mobile device based on the user selection of the one of the first plurality of selectable UI elements. The determination of the second plurality of selectable UI elements can be performed in response to a user-generated interrupt corresponding to the user selection. Each one of the second plurality of selectable UI elements can indicate distinct annotation data with which to associate the received image data.

The data annotation module 2130 can also be configured to cause the second plurality of selectable UI elements to be displayed on the mobile device. The data annotation module 2130 can be further configured to receive a user selection of one of the second plurality of UI elements.

Additionally, the data annotation module 2130 can be configured to associate the annotation data corresponding to the selected one of the second plurality of UI elements with the received image data. The annotation data and the received image data can be associated with the first user for processing by an online health provider service (e.g., health data system 130 in FIG. 1) with which the first user is registered.

The notification module 2140 can be configured to generate a plurality of notifications for a second user. It is noted that the terms “notification” and “alert” are used interchangeably within the present disclosure. The second user (e.g., system worker 140 in FIG. 1) can be different from the first user (e.g., patient user 110 in FIG. 1), and each one of the plurality of notifications can correspond to a different patient of the second user.

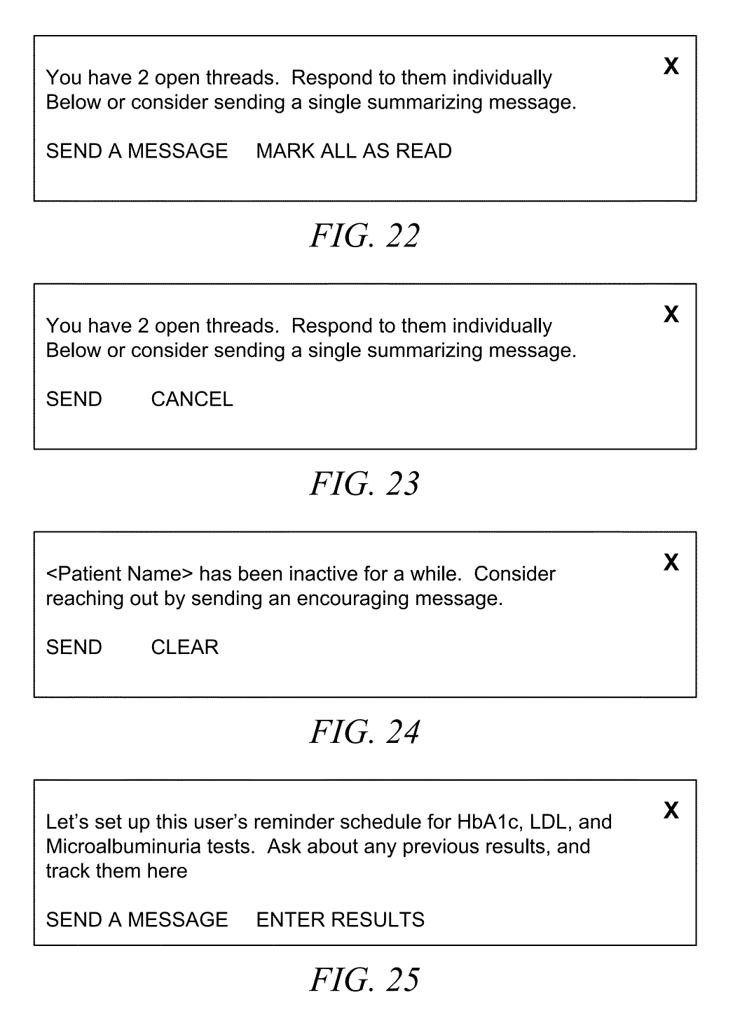

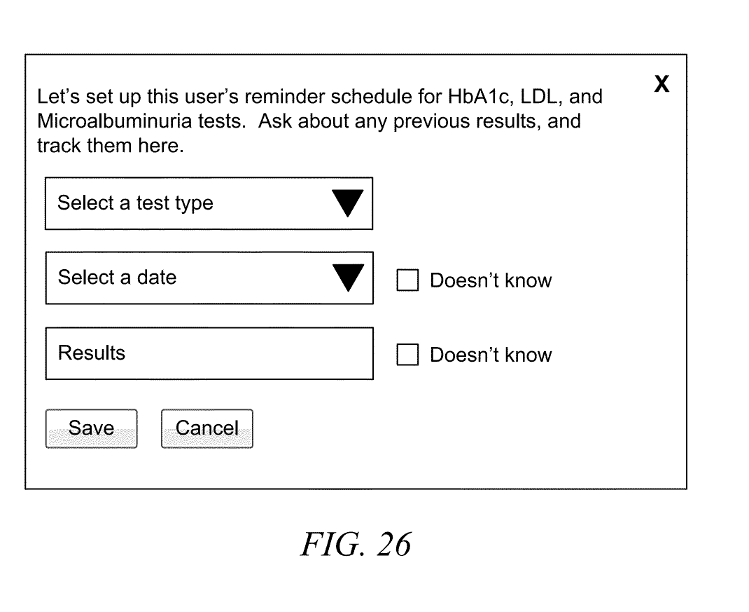

Notifications or alerts can contain several fields, including but not limited to: a prompt explaining the situation; a number of suggested or recommended actions (e.g., a recommendation to send a message, record lab results, initiate phone call, send educational material); a method of dismissing the notification if the coach deems it unnecessary; some additional context to help the coach decide upon an action (e.g., recent uploads from the patient, recent lab results); a priority value. FIGS. 22-26 illustrate notifications, in accordance with some example embodiments.

Notifications can be created based on a number of circumstances as the result of a trigger. Circumstances are attributes of a system (e.g., health data system 130 in FIG. 1) that influence the desired action in the context of the current intervention. These attributes can include, but are not limited to, overall snapshots of population health, existing health data about a particular patient, recent engagement of a particular patient, the priority of the other notifications in a current worker's queue, and the tasks that the current worker is certified to perform.

Triggers are actions that precipitate the creation or modification of a number of notifications. Triggers can include, but are not limited to: a user taking an action (e.g., uploading a photo, sending a message); periodic inspections of a user's recent engagement, triggered by the system itself; coaches entering information or summaries of a user's current health; and lab results coming in from a user's provider.

Note that in some circumstances, certain triggers may generate multiple notifications to be sent to different coaches with different levels of certification or involvement in the patient's care. Certain notifications can also be sent to family members, providers, the patient themselves, or other entities entirely. The examples of notifications disclosed herein are focused on notifications for coaches, but the notification framework is broad enough to encompass arbitrary notification behavior for any set of parties that are interested in being involved in a patient's care. Similar to the case of coach notifications, notifications for other parties can also be presented in a consistent style regardless of the current intervention or the patient's status within it.

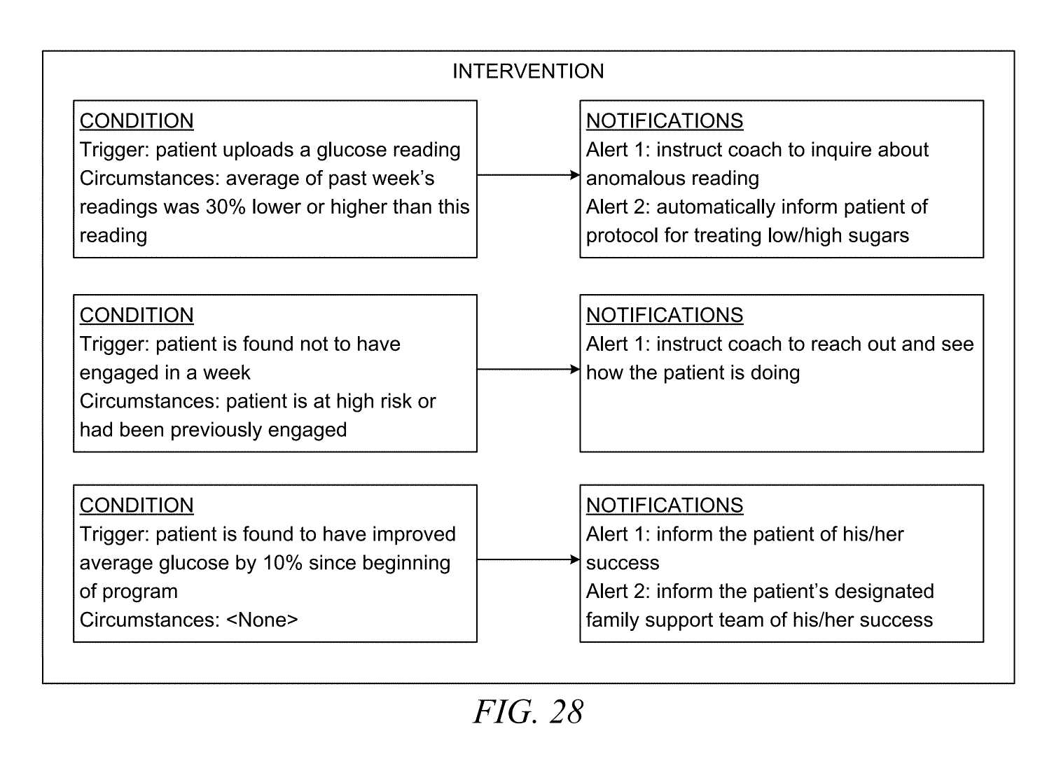

The intervention module 2150 can be configured to receive an intervention configuration input from a system worker. The intervention configuration input can be configured to configure an intervention for a user, such as a patient. As will be discussed in further detail below with respect to FIG. 28, the intervention can comprise one or more rules defining one or more actions to be performed in response to a determination of one or more corresponding conditions associated with the patient. The one or more actions to be performed can comprise sending a notification to the patient, the system worker, and/or another user different from the patient. The intervention module 2150 can store the configured intervention in a database, such as database(s) 134, and apply the stored intervention to data associated with the patient. Such data can include, but is not limited to, data indicating the patient's activity or lack of activity with respect to submitting information (e.g., patient has failed to upload a glucose reading for the last 7 days) and data indicating the health of the patient (e.g., the patient's glucose level has improved by 10% over the last 7 days).

Referring back to FIG. 21, the notification module 2140 can be configured to determine that the first user has failed to satisfy one or more predetermined criteria for user engagement, and transmit a notification to one or more other users different from the first user based on the determination that the first user has failed to satisfy the one or more predetermined criteria for user engagement. The one or more predetermined criteria for user engagement can comprise a predetermined minimum level of submission of image data corresponding to one of the image categories of the first plurality of selectable UI elements. The notification can comprise an indication that the first user has failed to satisfy the predetermined minimum level of submission of image data. In one example embodiment, the notification module 2140 can determine that a user has not submitted a photo of a glucometer reading for the last 5 days. Based on this lack of user engagement, the notification module 2140 can transmit a notification to a health care provider and/or family member, providing information about the user's lack of engagement.

Notifications can be assigned a priority value based on a number of factors. As previously mentioned, these factors can include, but are not limited to: the type of notification; the user's current health status; the user's past engagement on the platform; the interventions that a particular user is part of; and how busy (or recipient of the notification) the coach currently is.

The priority value can be on a single scale, and hence can be expressed in a variety of ways, including, but not limited to, as numbers (e.g., as a number between 0 and 1) or as levels (e.g., HIGH, MEDIUM, LOW). A collection of notifications for a particular coach can be gathered together in a coach's inbox. The coach can then simply proceed from top to bottom through the inbox, in descending order of notification priority, without needing to determine for himself or herself what the most important thing to do at a given moment is (e.g., which notifications to read and address first).

This prioritization feature is extremely useful in allowing coaches to scale up to taking care of large numbers of patients simultaneously. Without a simple, consistent method of prioritizing outstanding notifications, coaches would be overwhelmed by deciding which patient to care for next, and what particular action is appropriate for that patient in the moment in question based on their current status within a particular intervention.

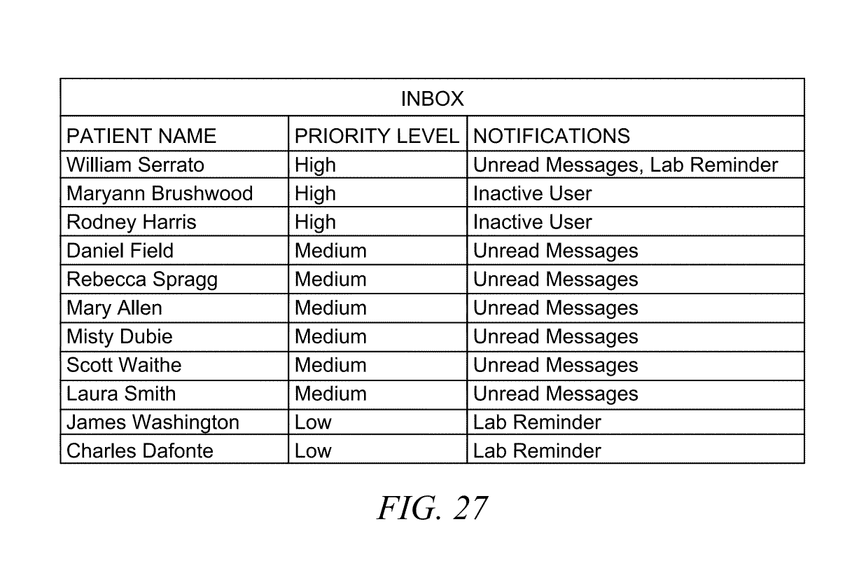

FIG. 27 illustrates an inbox of notifications for a health care provider, in accordance with some example embodiments. The inbox of notifications can comprise columns for patient name, summarized priority level, and identification or indication of the current notifications.

Accordingly, referring back to FIG. 21, the notification module 2140 can be configured to determine a corresponding priority value for each one of the plurality of notifications based on one or more priority factors. The priority factors can be independent from any direction by the corresponding patient (or another user) for the corresponding priority value of the corresponding notification. For example, the priority factors can exclude an explicit identification of priority for the notification, such as an explicit flagging of a message as a high priority by a person who authors or sends the message. The priority factors can comprise any combination of one or more of a classification of the corresponding notification (e.g., Unread Messages, Lab Reminder, Inactive User), health status information of the corresponding patient of the corresponding notification (e.g., patient is at high risk), historical information of interaction by the corresponding patient of the corresponding notification with the online health provider service (e.g., patient is found not to have interacted with the online health provider service in more than a week), intervention information indicating one or more approaches for providing support to the corresponding patient of the corresponding notification, and information indicating a level of availability of the second user (e.g., information about the schedule of the health care provider, the number of tasks assigned to the health care provider that are still uncompleted).

The notification module 2140 can additionally be configured to determine a presentation configuration of the plurality of notifications based on their corresponding priority values, and then cause the plurality of notifications to be displayed to the second user based on the presentation configuration. The presentation configuration can comprise a configuration for how the notifications are to be displayed. Therefore, the priority values can affect or influence how the notifications are displayed, such as the ordering of the notifications in the coach's inbox.

The notification module 2140 can determine the presentation configuration by ranking the plurality of notifications based on their corresponding priority values, and can cause at least a portion of the plurality of notifications to be displayed on a page based on the ranking. For example, in FIG. 27, the notifications are displayed based on a ranking of their priority levels from top to bottom in descending order (e.g., highest priority notifications at the top and lowest priority notifications at the bottom).

The notification module 2140 can also determine the presentation configuration by determining an indication of the corresponding priority value for each one of the plurality of notifications, and can cause at least a portion of the plurality of notifications to be displayed on a page along with their corresponding indications of their corresponding priority values. For example, in FIG. 27, the the notifications are displayed along with indications of their corresponding priority levels (HIGH, MEDIUM, LOW).

Using the features of the present disclosure, an intervention can be implemented via a collection of rules for generating notifications. Recall that notifications can be configured to suggest arbitrary actions to whomever should take that action. Interventions represent an organization's design decisions about how to deploy coaching support in order to make their population healthier. Each intervention can be applied to some set of users. Interventions can be within an organization, across organizations, exclusive with each other, or overlapping. Each user can therefore be in one or more interventions.

In order to define an intervention, an organization can supply a set of conditions. A condition defines or is mapped to a set of notifications to generate based on the appropriate set of circumstances and triggers. FIG. 28 illustrates a logic of an intervention, in accordance with some example embodiments. In FIG. 28, each “Notification” has the properties previously discussed with respect to notifications, including a suggested action. The intervention can be applied to the desired group of users. These logic details of the interventions can be stored in the database(s) 134 of the health data system 130 in FIG. 1, where they can be accessed and retrieved for use in providing notifications.

Once an intervention is active, coaches (or others) can receive the notifications according to the rules specified in the intervention. Since these notifications are consistently presented across interventions, coaches need not be aware of the global structure of the intervention or any details about which patients are in which interventions. They can simply react locally according to their best judgment given the particular situation the notification is prompting them to consider, thereby allowing coaches to be dramatically more efficient, since they can focus on the substance of how to coach well rather than having to keep track of a large amount of procedural information. Moreover, at the organizational level, it allows organizations to flexibly and cheaply experiment with different approaches to population health management, rather than having to undergo significant cost, overhead, and coach training each time they wish to institute a new intervention.

Interventions today are typically designed to be delivered via one specific channel. It is expensive and difficult to custom-design interventions to work across multiple channels. An organization might decide to offer in-person diabetes education classes, phone-based follow-up outreach, or optional participation in a smartphone-based coaching program. However, these interventions are not designed to work seamlessly across multiple channels, which is a significant problem, since the patient population within a given health system is heterogeneous with regard to their level of access and the channels they have available. Interventions designed to work within one channel cannot apply broadly across the whole population, and only work on those patients who can access the particular channel through which the intervention is being offered.

The features of the present disclosure enable interventions to work seamlessly across different channels. Some examples of cross-channel behavior within an intervention are: any given piece of content a user may receive will be tailored to the channels they can access; certain pieces of content may not be delivered to users with particular channel sets; and rules for generating coach notifications can depend on the user's available channels.

One part of this channel optimization process is the channel selection for a piece of content. For example, some users may possess smartphones, in which case they can receive messages via a smartphone application. Other users may possess older, SMS-capable non-smartphones, in which case they can receive messages via SMS. Note that users may receive content via one channel, multiple channels, or no channels (e.g., if the content is too complex for their available channels). Additionally, channel selection can be automatic in some cases, and manually done by the coach in others.

Another part of this process is content optimization. Certain types of content may exist in multiple forms and be delivered differently depending on the channels. For instance, a smartphone user may receive a more complex set of educational materials, such as video, whereas a user with an SMS-capable non-smartphone may receive a simplified set of text-only material via SMS. The interventions can define their own custom methods for using both channel selection and content optimization.

Users can have access to different sets of channels. When a given piece of content is to be delivered to a user, it can be delivered via arbitrary subsets of the channels that a user has available. For instance, a coach message can be delivered via mobile push if the user has a smartphone, but via SMS if not (or via both). Or, educational materials may be made available via email, in a web portal, and also in physical form via paper mail.

Certain automated systems of the present disclosure can select the appropriate channels for different types of content. In the case of educational materials, the system can automatically perform the heavy lifting. The coach needs only to confirm from their portal that a particular piece of educational material should be sent to the user, and the system will send it via the appropriate channel(s). In other cases, it may be appropriate to allow the coach to override the automatic channel selection, or, for the coach to make the decision themselves. For example, the system may assume that a message should be delivered via mobile push, but if the coach wants to ensure the patient sees it with high priority, the coach could override the system and send the message via SMS instead (or as well). In other cases, coaches may need to choose the appropriate channels if no defaults are given.

Referring back to FIG. 21, in some example embodiments, the notification module 2140 can be configured to generate a message for the first user, and select, from a plurality of channels of communication, at least one channel of communication for the message based on at least one of profile information of the first user, a classification of the message, and content of the message. The notification module 2140 can then transmit the message to the first user via the selected channel(s) of communication. The plurality of channels of communication can include, but is not limited to, e-mail, text messaging, multimedia messaging, a mobile application, and a web page.

Certain pieces of content can also differ in form in different channels. For example, educational materials can be delivered in complex form for users with access to a smartphone, and include embedded video and rich media. That same educational material can be simplified and delivered as text-only via SMS, or, picture-and-text via MMS.

In some example embodiments, the notification module 2140 can be configured to determine a channel of communication for a message for the first user, determine content of the message based on the determined channel of communication, generate the message including the determined content, and transmit the generated message to the first user via the determined channel of communication.

Channel management is a particularly complex aspect of designing interventions well. Interventions can customize the way in which channels are managed as described above, to experiment with different approaches and see what works best, or do operate differently with different patient populations.

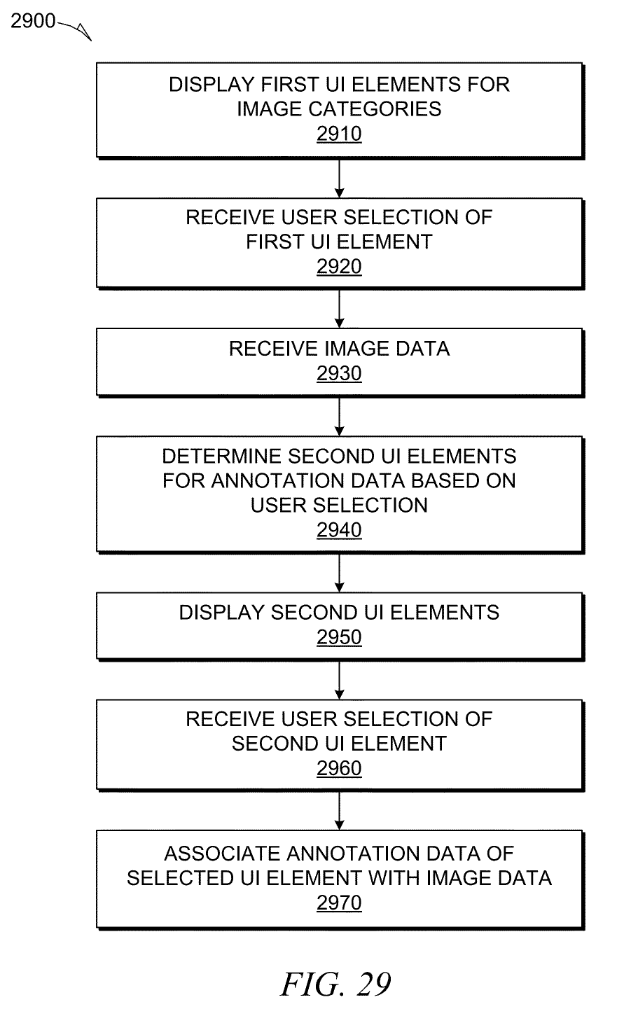

FIG. 29 is a flowchart illustrating a method 2900 of annotating data, in accordance with some example embodiments. Method 2900 can be performed by processing logic that can comprise hardware (e.g., circuitry, dedicated logic, programmable logic, microcode, etc.), software (e.g., instructions run on a processing device), or a combination thereof. In one example embodiment, the method 2900 is performed by the health data system 130 of FIG. 1, or any combination of one or more of health data module(s) 132 of FIGS. 1 and 21, as described above.

At operation 2910, a first plurality of selectable UI elements can be caused to be displayed on a mobile device of a first user. Each one of the first plurality of selectable UI elements can indicate a distinct image category. In some example embodiments, the first plurality of selectable UI elements comprises a first selectable UI element indicating a food image category for food data and a second selectable UI element indicating a measurement image category for medical device measurement data. At operation 2920, a user selection, by the first user, of one of the first plurality of selectable UI elements can be received. At operation 2930, image data captured by an image capture device on the mobile device can be received. At operation 2940, a second plurality of selectable UI elements can be determined to be displayed on the mobile device based on the user selection of the one of the first plurality of selectable UI elements. The determination of the second plurality of selectable UI elements can be responsive to a user-generated interrupt corresponding to the user selection, and each one of the second plurality of selectable UI elements can indicate distinct annotation data with which to associate the received image data. At operation 2950, the second plurality of selectable UI elements can be caused to be displayed on the mobile device. At operation 2960, a user selection, by the first user, of one of the second plurality of UI elements can be received. At operation 2970, the annotation data corresponding to the selected one of the second plurality of UI elements can be associated with the received image data. The annotation data and the received image data can be further associated with the first user for processing by an online health provider service with which the first user is registered.

It is contemplated that any of the other features described within the present disclosure can be incorporated into method 2900.

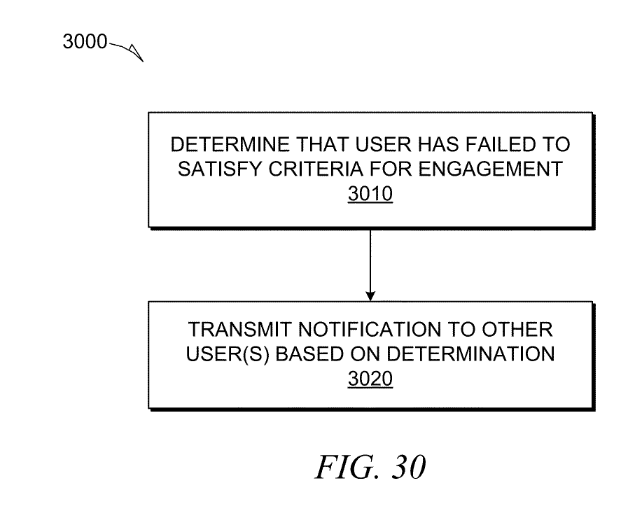

FIG. 30 is a flowchart illustrating a method of transmitting a notification, in accordance with some example embodiments. Method 3000 can be performed by processing logic that can comprise hardware (e.g., circuitry, dedicated logic, programmable logic, microcode, etc.), software (e.g., instructions run on a processing device), or a combination thereof. In one example embodiment, the method 3000 is performed by the health data system 130 of FIG. 1, or any combination of one or more of health data module(s) 132 of FIGS. 1 and 21, as described above.

At operation 3010, it can be determined that a first user has failed to satisfy one or more predetermined criteria for user engagement. The one or more predetermined criteria for user engagement can comprise a predetermined minimum level of submission of image data corresponding to one of the image categories of the first plurality of selectable UI elements. At operation 3020, a notification can be transmitted to one or more other users different from the first user based on the determination that the first user has failed to satisfy the one or more predetermined criteria for user engagement. The notification can comprise an indication that the first user has failed to satisfy the predetermined criteria for user engagement. Such an indication can include, but is not limited to, a statement that the user has failed to satisfy the predetermined criteria. Alternatively, the operations of method 3000 can be directed towards providing a notification based on a user sufficiently satisfying the one or more predetermined criteria for user engagement. For example, at operation 3010, it can alternatively be determined that a first user has satisfied the one or more predetermined criteria for user engagement. At operation 3020, a notification can then be transmitted to one or more other users different from the first user based on the determination that the first user has failed to satisfy the one or more predetermined criteria for user engagement. The notification can comprise an indication that the first user has satisfied the one or more predetermined criteria. Such an indication can include, but is not limited to, a statement that the user has satisfied the predetermined criteria.

It is contemplated that any of the other features described within the present disclosure can be incorporated into method 3000.

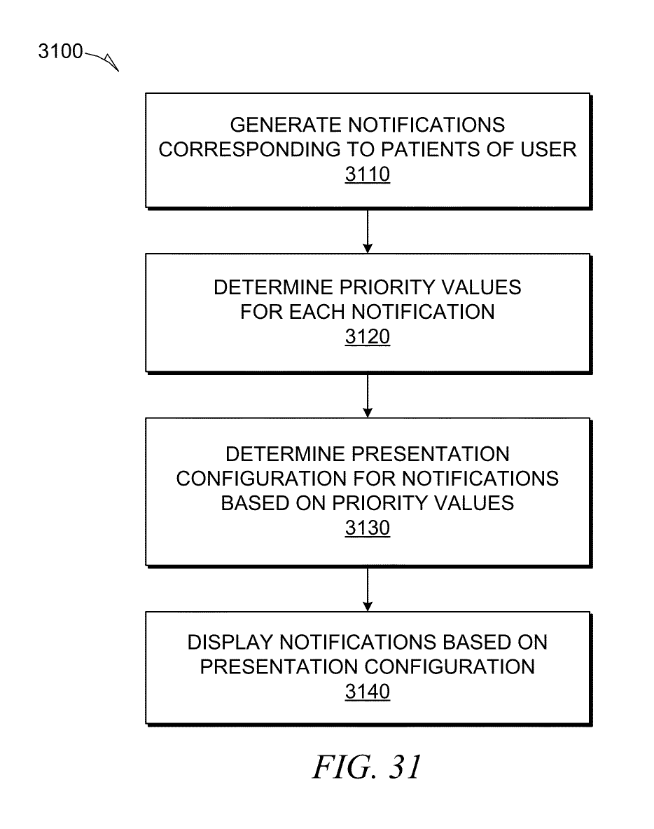

FIG. 31 is a flowchart illustrating a method of prioritizing notifications, in accordance with some example embodiments. Method 3100 can be performed by processing logic that can comprise hardware (e.g., circuitry, dedicated logic, programmable logic, microcode, etc.), software (e.g., instructions run on a processing device), or a combination thereof. In one example embodiment, the method 3100 is performed by the health data system 130 of FIG. 1, or any combination of one or more of health data module(s) 132 of FIGS. 1 and 21, as described above.

At operation 3110, a plurality of notifications for a second user different from the first user can be generated. Each one of the plurality of notifications can correspond to a different patient of the second user.

At operation 3120, a corresponding priority value can be determined for each one of the plurality of notifications based on one or more priority factors that are independent from any direction by the corresponding patient for the corresponding priority value of the corresponding notification. In some example embodiments, the one or more priority factors can comprise at least one of a classification of the corresponding notification, health status information of the corresponding patient of the corresponding notification, historical information of interaction by the corresponding patient of the corresponding notification with the online health provider service, intervention information indicating one or more approaches for providing support to the corresponding patient of the corresponding notification, and information indicating a level of availability of the second user.

At operation 3130, a presentation configuration of the plurality of notifications can be determined based on their corresponding priority values. At operation 3140, the plurality of notifications can be caused to be displayed to the second user based on the presentation configuration.

In some example embodiments, determining the presentation configuration at operation 3130 comprises ranking the plurality of notifications based on their corresponding priority values, and causing the plurality of notification to be displayed to the second user based on the presentation configuration at operation 3140 comprises causing at least a portion of the plurality of notifications to be displayed on a page based on the ranking.

In some example embodiments, determining the presentation configuration at operation 3130 comprises determining an indication of the corresponding priority value for each one of the plurality of notifications, and causing the plurality of notification to be displayed to the second user based on the presentation configuration at operation 3140 comprises causing at least a portion of the plurality of notifications to be displayed on a page along with their corresponding indications of their corresponding priority values.

It is contemplated that any of the other features described within the present disclosure can be incorporated into method 3100.

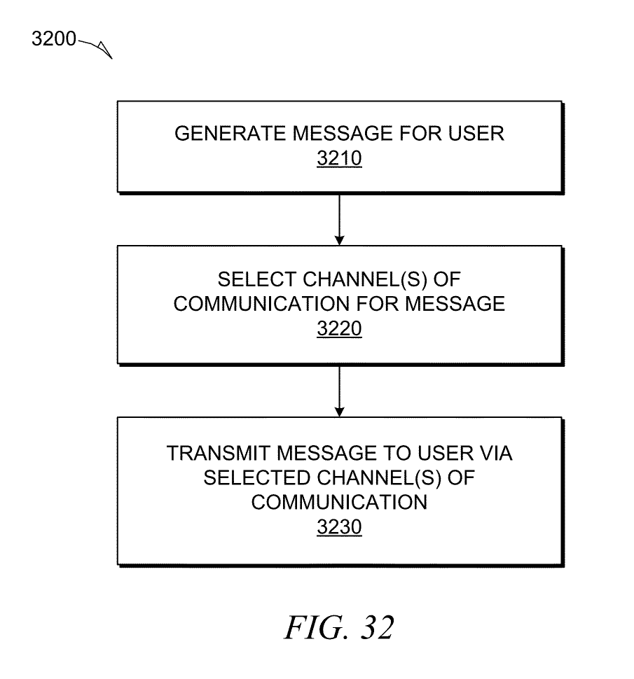

FIG. 32 is a flowchart illustrating a method of channel optimization for a message, in accordance with some example embodiments. Method 3200 can be performed by processing logic that can comprise hardware (e.g., circuitry, dedicated logic, programmable logic, microcode, etc.), software (e.g., instructions run on a processing device), or a combination thereof. In one example embodiment, the method 3200 is performed by the health data system 130 of FIG. 1, or any combination of one or more of health data module(s) 132 of FIGS. 1 and 21, as described above.

At operation 3210, a message for the first user is generated. At operation 3220, at least one channel of communication from a plurality of channels of communication can be selected for the message based on at least one of profile information of the first user, a classification of the message, and content of the message. At operation 3230, the message can be transmitted to the first user via the selected channel(s) of communication.

It is contemplated that any of the other features described within the present disclosure can be incorporated into method 3200.

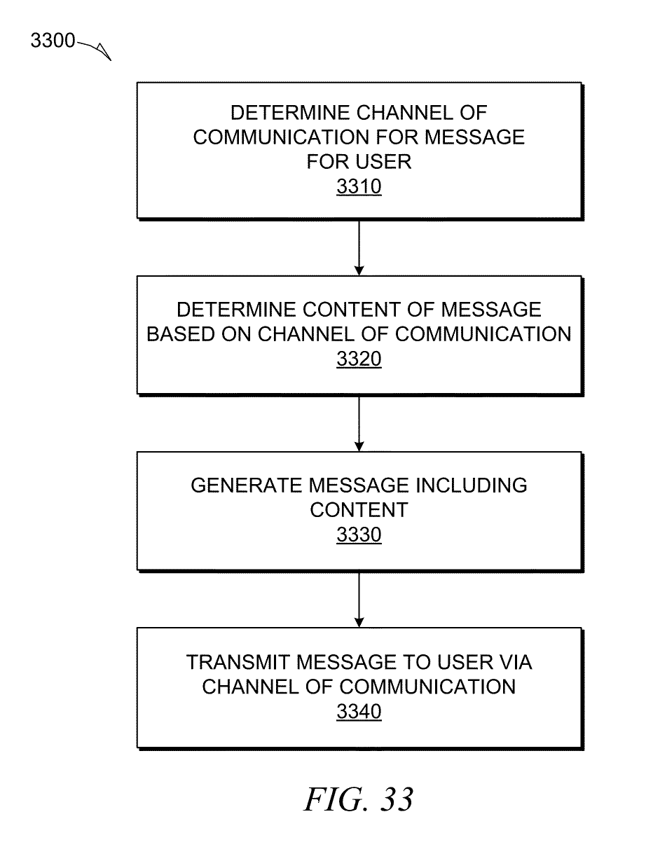

FIG. 33 is a flowchart illustrating a method of content optimization for a message, in accordance with some example embodiments. Method 3300 can be performed by processing logic that can comprise hardware (e.g., circuitry, dedicated logic, programmable logic, microcode, etc.), software (e.g., instructions run on a processing device), or a combination thereof. In one example embodiment, the method 3300 is performed by the health data system 130 of FIG. 1, or any combination of one or more of health data module(s) 132 of FIGS. 1 and 21, as described above.

At operation 3310, a channel of communication can be determined for a message for the first user. At operation 3320, content of the message can be determined based on the determined channel of communication. At operation 3330, the message can be generated to include the determined content. At operation 3340, the generated message can be transmitted to the first user via the determined channel of communication.

It is contemplated that any of the other features described within the present disclosure can be incorporated into method 3300.

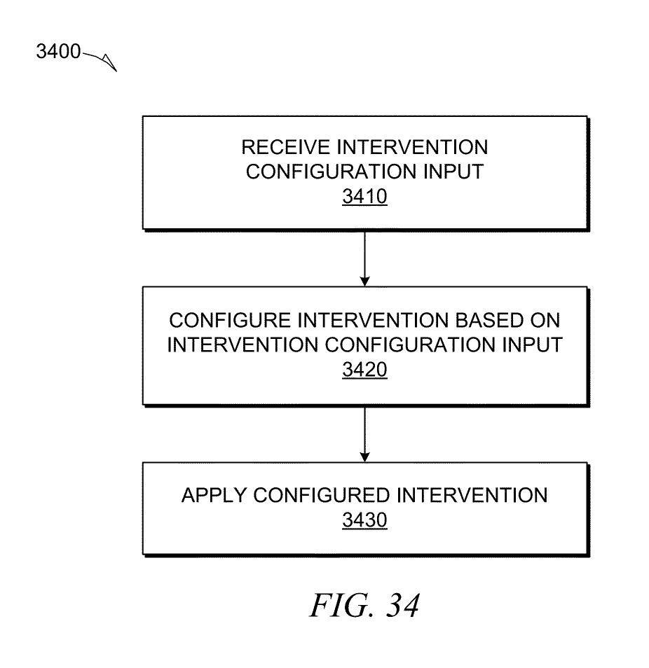

FIG. 34 is a flowchart illustrating a method 3400 of intervention management, in accordance with some example embodiments. Method 3300 can be performed by processing logic that can comprise hardware (e.g., circuitry, dedicated logic, programmable logic, microcode, etc.), software (e.g., instructions run on a processing device), or a combination thereof. In one example embodiment, the method 3300 is performed by the health data system 130 of FIG. 1, or any combination of one or more of health data module(s) 132 of FIGS. 1 and 21, as described above.

At operation 3410, an intervention configuration input can be received from a second user different from the first user. The intervention configuration input can be configured to configure an intervention for the first user. The intervention can comprise one or more rules defining one or more actions to be performed in response to a determination of one or more corresponding conditions associated with the first user. The one or more actions to be performed can comprise sending a notification to the first user, the second user, and/or some other user different from the first user. At operation 3420, the intervention can be configured based on the intervention configuration input and stored in a database. At operation 3430, the intervention can be applied to data associated with the first user.

It is contemplated that any of the other features described within the present disclosure can be incorporated into method 3400.

The features of present disclosure provide a huge improvement in the utility and usability of health data recording, storing, and usage. For patients, it affords them a simple, painless way of uploading a myriad of types of health data without any cognitive overhead. Patients end up with a useful structured view into their own behavior and biometrics. The ease of using the features disclosed herein will result in much higher usage rates, which will give caregivers a much more robust and useful view of the health of their patient population, and thereby enable them to deliver much more effective care at scale. For healthcare workers and corporations, the features of present disclosure provide a huge improvement in the types of outreach that are feasible to design, implement, and experiment with. Using these features allows healthcare corporations to define complex interventions and experiment with modifications to them much more easily than they could previously, in large part because their employees can use the system described here to effectively manage outreach to a much larger number of patients than they could previously. Additionally, the rule-sets and procedures for these complex interventions no longer need to be memorized by the workers who are in charge of carrying out the outreach in question, leaving them free to focus on the substance of what to say to their patients.

The present disclosure describes several different features and embodiments. It is contemplated that any features and embodiments disclosed herein can be combined with any other features and embodiments disclosed herein. Accordingly, hybrid embodiments that combine certain features of one embodiment with other features of another embodiment are within the scope of the present disclosure.

### Example Mobile Device

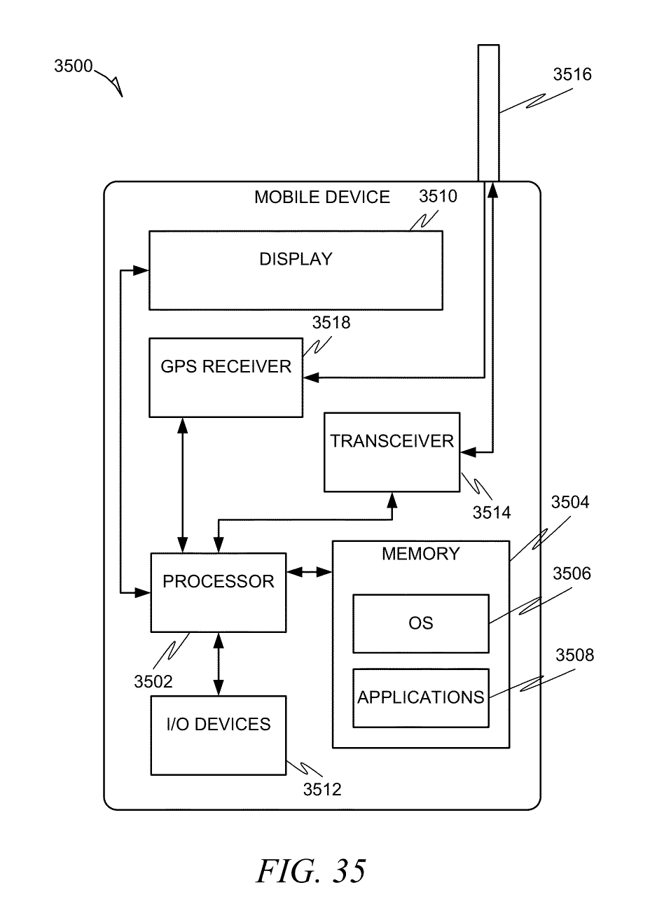

FIG. 35 is a block diagram illustrating a mobile device 3500, according to some example embodiments. The mobile device 3500 can include a processor 3502. The processor 3502 can be any of a variety of different types of commercially available processors suitable for mobile devices 3500 (for example, an XScale architecture microprocessor, a Microprocessor without Interlocked Pipeline Stages (MIPS) architecture processor, or another type of processor). A memory 3504, such as a random access memory (RAM), a Flash memory, or other type of memory, is typically accessible to the processor 3502. The memory 3504 can be adapted to store an operating system (OS) 3506, as well as application programs 3508, such as a mobile location enabled application that can provide LBSs to a user. The processor 3502 can be coupled, either directly or via appropriate intermediary hardware, to a display 3510 and to one or more input/output (I/O) devices 3512, such as a keypad, a touch panel sensor, a microphone, and the like. Similarly, in some example embodiments, the processor 3502 can be coupled to a transceiver 3514 that interfaces with an antenna 3516. The transceiver 3514 can be configured to both transmit and receive cellular network signals, wireless data signals, or other types of signals via the antenna 3516, depending on the nature of the mobile device 3500. Further, in some configurations, a GPS receiver 3518 can also make use of the antenna 3516 to receive GPS signals.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 214 of FIG. 2) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

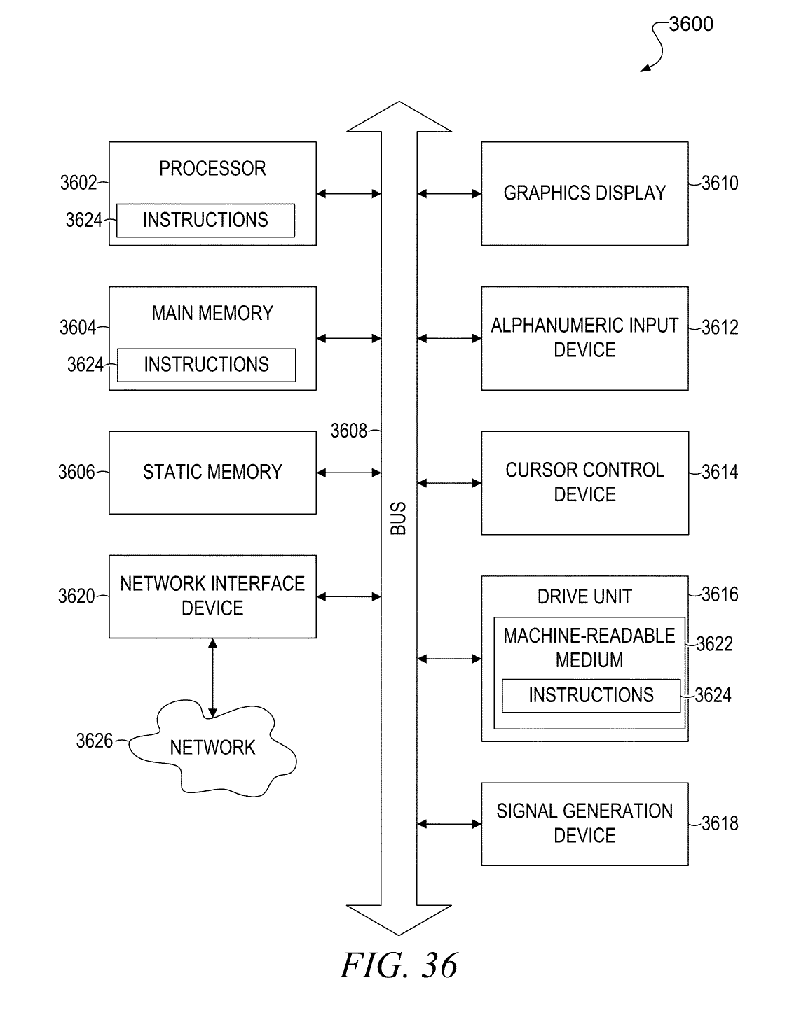

FIG. 36 is a block diagram of a machine in the example form of a computer system 3600 within which instructions 3624 for causing the machine to perform any one or more of the methodologies discussed herein may be executed, in accordance with an example embodiment. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 3600 includes a processor 3602 (e.g., a central processing unit (CPU), a graphics processing unit (GPU) or both), a main memory 3604 and a static memory 3606, which communicate with each other via a bus 3608. The computer system 3600 may further include a video display unit 3610 (e.g., a liquid crystal display (LCD) or a cathode ray tube (CRT)). The computer system 3600 also includes an alphanumeric input device 3612 (e.g., a keyboard), a user interface (UI) navigation (or cursor control) device 3614 (e.g., a mouse), a disk drive unit 3616, a signal generation device 3618 (e.g., a speaker) and a network interface device 3620.

The disk drive unit 3616 includes a machine-readable medium 3622 on which is stored one or more sets of data structures and instructions 3624 (e.g., software) embodying or utilized by any one or more of the methodologies or functions described herein. The instructions 3624 may also reside, completely or at least partially, within the main memory 3604 and/or within the processor 3602 during execution thereof by the computer system 3600, the main memory 3604 and the processor 3602 also constituting machine-readable media. The instructions 3624 may also reside, completely or at least partially, within the static memory 3606.

While the machine-readable medium 3622 is shown in an example embodiment to be a single medium, the term “machine-readable medium” may include a single medium or multiple media (e.g., a centralized or distributed database, and/or associated caches and servers) that store the one or more instructions 3624 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 3624 may further be transmitted or received over a communications network 3626 using a transmission medium. The instructions 3624 may be transmitted using the network interface device 3620 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a data category module configured to:
cause a first plurality of selectable user interface (UI) elements to be displayed on a mobile device to a first user, each one of the first plurality of selectable UI elements indicating a distinct image category; and
receive a user selection of one of the first plurality of selectable UI elements;
a data reception module configured to receive image data captured by an image capture device on the mobile device; and
a data annotation module, executable on at least one processor, configured to:
determine a second plurality of selectable UI elements to be displayed on the mobile device based on the user selection of the one of the first plurality of selectable UI elements, the determination of the second plurality of selectable UI elements being responsive to a user-generated interrupt corresponding to the user selection, each one of the second plurality of selectable UI elements indicating distinct annotation data with which to associate the received image data;
cause the second plurality of selectable UI elements to be displayed on the mobile device to the first user;
receive a user selection of one of the second plurality of UI elements; and
associate the annotation data corresponding to the selected one of the second plurality of UI elements with the received image data, the annotation data and the received image data being further associated with the first user for processing by an online health provider service with which the first user is registered.

2. The system of claim 1, wherein the first plurality of selectable UI elements comprises a first selectable UI element indicating a food image category for food data and a second selectable UI element indicating a measurement image category for medical device measurement data.

3. The system of claim 1, further comprising a notification module configured to:
determine that the first user has failed to satisfy one or more predetermined criteria for user engagement, the one or more predetermined criteria for user engagement comprising a predetermined minimum level of submission of image data corresponding to one of the image categories of the first plurality of selectable UI elements; and
transmit a notification to one or more other users different from the first user based on the determination that the first user has failed to satisfy the one or more predetermined criteria for user engagement, the notification comprising an indication that the first user has failed to satisfy the predetermined minimum level of submission of image data.

4. The system of claim 1, further comprising a notification module configured to:
determine that the first user has satisfied one or more predetermined criteria for user engagement, the one or more predetermined criteria for user engagement comprising a predetermined minimum level of submission of image data corresponding to one of the image categories of the first plurality of selectable UI elements; and
transmit a notification to one or more other users different from the first user based on the determination that the first user has satisfied the one or more predetermined criteria for user engagement, the notification comprising an indication that the first user has satisfied the predetermined minimum level of submission of image data.

5. The system of claim 1, further comprising a notification module configured to:
generate a plurality of notifications for a second user different from the first user, each one of the plurality of notifications corresponding to a different patient of the second user;
determine a corresponding priority value for each one of the plurality of notifications based on one or more priority factors that are independent from any direction by the corresponding patient for the corresponding priority value of the corresponding notification;
determine a presentation configuration of the plurality of notifications based on their corresponding priority values; and
cause the plurality of notifications to be displayed to the second user based on the presentation configuration.

6. The system of claim 5, wherein the one or more priority factors comprise at least one of a classification of the corresponding notification, health status information of the corresponding patient of the corresponding notification, historical information of interaction by the corresponding patient of the corresponding notification with the online health provider service, intervention information indicating one or more approaches for providing support to the corresponding patient of the corresponding notification, and information indicating a level of availability of the second user.

7. The system of claim 5, wherein determining the presentation configuration comprises ranking the plurality of notifications based on their corresponding priority values, and causing the plurality of notification to be displayed to the second user based on the presentation configuration comprises causing at least a portion of the plurality of notifications to be displayed on a page based on the ranking.

8. The system of claim 5, wherein determining the presentation configuration comprises determining an indication of the corresponding priority value for each one of the plurality of notifications, and causing the plurality of notification to be displayed to the second user based on the presentation configuration comprises causing at least a portion of the plurality of notifications to be displayed on a page along with their corresponding indications of their corresponding priority values.

9. The system of claim 1, further comprising a notification module configured to:
generate a message for the first user;
select, from a plurality of channels of communication, at least one channel of communication for the message based on at least one of profile information of the first user, a classification of the message, and content of the message; and
transmit the message to the first user via the selected at least one channel of communication.

10. The system of claim 9, wherein the plurality of channels of communication comprises e-mail, text messaging, multimedia messaging, a mobile application, and a web page.

11. The system of claim 1, further comprising a notification module configured to:
determine a channel of communication for a message for the first user;
determine content of the message based on the determined channel of communication;
generate the message including the determined content; and
transmit the generated message to the first user via the determined channel of communication.

12. The system of claim 1, further comprising an intervention module configured to:
receive an intervention configuration input from a second user different from the first user, the intervention configuration input configured to configure an intervention for the first user, the intervention comprising one or more rules defining one or more actions to be performed in response to a determination of one or more corresponding conditions associated with the first user;
configuring the intervention in a database based on the intervention configuration input; and
apply the intervention to data associated with the first user.

13. The system of claim 12, wherein the one or more actions to be performed comprise sending a notification to the second user.

14. A method comprising:
causing a first plurality of selectable user interface (UI) elements to be displayed on a mobile device of a first user, each one of the first plurality of selectable UI elements indicating a distinct image category;
receiving a user selection, by the first user, of one of the first plurality of selectable UI elements;
receiving image data captured by an image capture device on the mobile device;
determining a second plurality of selectable UI elements to be displayed on the mobile device based on the user selection of the one of the first plurality of selectable UI elements, the determining of the second plurality of selectable UI elements being responsive to a user-generated interrupt corresponding to the user selection, each one of the second plurality of selectable UI elements indicating distinct annotation data with which to associate the received image data;
causing the second plurality of selectable UI elements to be displayed on the mobile device;
receiving a user selection, by the first user, of one of the second plurality of UI elements; and
associating the annotation data corresponding to the selected one of the second plurality of UI elements with the received image data, the annotation data and the received image data being further associated with the first user for processing by an online health provider service with which the first user is registered.

15. The method of claim 14, wherein the first plurality of selectable UI elements comprises a first selectable UI element indicating a food image category for food data and a second selectable UI element indicating a measurement image category for medical device measurement data.

16. The method of claim 14, further comprising:
determining that the first user has failed to satisfy one or more predetermined criteria for user engagement, the one or more predetermined criteria for user engagement comprising a predetermined minimum level of submission of image data corresponding to one of the image categories of the first plurality of selectable UI elements; and
transmitting a notification to one or more other users different from the first user based on the determination that the first user has failed to satisfy the one or more predetermined criteria for user engagement, the notification comprising an indication that the first user has failed to satisfy the predetermined minimum level of submission of image data.

17. The method of claim 14, further comprising:
generating a plurality of notifications for a second user different from the first user, each one of the plurality of notifications corresponding to a different patient of the second user;
determining a corresponding priority value for each one of the plurality of notifications based on one or more priority factors that are independent from any direction by the corresponding patient for the corresponding priority value of the corresponding notification;
determining a presentation configuration of the plurality of notifications based on their corresponding priority values; and
causing the plurality of notifications to be displayed to the second user based on the presentation configuration.

18. The method of claim 17, wherein the one or more priority factors comprise at least one of a classification of the corresponding notification, health status information of the corresponding patient of the corresponding notification, historical information of interaction by the corresponding patient of the corresponding notification with the online health provider service, intervention information indicating one or more approaches for providing support to the corresponding patient of the corresponding notification, and information indicating a level of availability of the second user.

19. The method of claim 17, wherein determining the presentation configuration comprises ranking the plurality of notifications based on their corresponding priority values, and causing the plurality of notification to be displayed to the second user based on the presentation configuration comprises causing at least a portion of the plurality of notifications to be displayed on a page based on the ranking.

20. A non-transitory machine-readable storage device, tangibly embodying a set of instructions that, when executed by at least one processor, causes the at least one processor to perform operations comprising:
causing a first plurality of selectable user interface (UI) elements to be displayed on a mobile device of a first user, each one of the first plurality of selectable UI elements indicating a distinct image category;
receiving a user selection of one of the first plurality of selectable UI elements;
receiving image data captured by an image capture device on the mobile device;
determining a second plurality of selectable UI elements to be displayed on the mobile device based on the user selection of the one of the first plurality of selectable UI elements, the determining of the second plurality of selectable UI elements being responsive to a user-generated interrupt corresponding to the user selection, each one of the second plurality of selectable UI elements indicating distinct annotation data with which to associate the received image data;
causing the second plurality of selectable UI elements to be displayed on the mobile device;
receiving a user selection of one of the second plurality of UI elements; and
associating the annotation data corresponding to the selected one of the second plurality of UI elements with the received image data, the annotation data and the received image data being further associated with the first user for processing by an online health provider service with which the first user is registered.
